(19) United States
(12) Patent Application Publication
(10) Pub. No.: US 2026/0162413 A1
(43) Pub. Date: Jun. 11, 2026

(54) Adaptive Input Sampling for Machine Learning

(71) Applicant: DeepMind Technologies Limited, London (GB)

(72) Inventors: Obaid Sarvana, Plainfield, IL (US); Florian Nils Hartmann, Zurich (CH); Swaroop Ranjan Mishra, Santa Clara, CA (US); Matthew Sharifi, Kilchberg (CH); Naina Raisinghani, Union City, CA (US)

(21) Appl. No.: 18/977,092

(22) Filed: Dec. 11, 2024

(51) Int. Cl. G06V 10/778; G06T 7/20; G06V 10/74; G06V 10/774; G06V 10/82

(52) U.S. Cl. CPC G06V 10/778; G06T 7/20; G06V 10/761; G06V 10/774; G06V 10/82; G06T 2207/10016; G06T 2207/20081

(57) ABSTRACT

Systems and methods are provided. An example method can include providing, by a computing system comprising one or more computing devices, to a first machine-learned model, one or more first video frames. The example method can include determining, by the computing system based at least in part on the one or more first video frames, whether to provide one or more second video frames to the first machine-learned model. The example method can include providing, by the computing system responsive to determining that the one or more second video frames should be provided to the first machine-learned model, the one or more second video frames to the first machine-learned model. The example method can include generating, by the first machine-learned model based at least in part on the one or more second video frames, an output

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include providing, by a computing system comprising one or more computing devices, to a first machine-learned model, one or more first video frames. The example method can include determining, by the computing system based at least in part on the one or more first video frames, whether to provide one or more second video frames to the first machine-learned model. The example method can include providing, by the computing system responsive to determining that the one or more second video frames should be provided to the first machine-learned model, the one or more second video frames to the first machine-learned model. The example method can include generating, by the first machine-learned model based at least in part on the one or more second video frames, an output.

In the example method, the one or more second video frames can be stored in a video cache. The method can include retrieving, by the computing system responsive to determining that the one or more second video frames should be provided to the first machine-learned model, the one or more second video frames from the video cache.

In the example method, determining whether the one or more second video frames should be provided to the first machine-learned model can include determining whether to increase a sampling rate at which a video stream comprising a plurality of video frames is provided to the first machine-learned model. In the example method, providing the one or more second video frames to the first machine-learned model can include increasing the sampling rate.

In the example method, determining whether to increase the sampling rate can include determining based at least in part on a metric of difference between at least one earlier frame of the one or more first video frames and at least one later frame of the one or more first video frames.

In the example method, determining whether to increase the sampling rate can include determining based at least in part on a metric indicative of an amount of motion associated with the one or more first video frames.

The example method can include determining, by the computing system based at least in part on the one or more second video frames, that the sampling rate should be decreased. The example method can include decreasing, by the computing system responsive to determining that the sampling rate should be decreased, the sampling rate.

In the example method, determining whether to provide the one or more second video frames to the first machine-learned model can include providing, by the computing system to the first machine-learned model or a second machine-learned model, a first input context comprising the one or more first video frames. In the example method, determining whether to provide the one or more second video frames to the first machine-learned model can include receiving, by the computing system from the first machine-learned model or the second machine-learned model, data indicating whether the one or more second video frames should be provided to the first machine-learned model.

In the example method, the data indicating whether the one or more second video frames should be provided to the first machine-learned model can include one or more of: frame identification data identifying the one or more second video frames; confidence data indicative of a confidence of the first machine-learned model in relation to one or more queries; one or more output tokens indicative of a request to increase a sampling rate; and one or more output tokens indicative of a request to increase a frame resolution.

In the example method, the first input context further can include one or more of: instruction content comprising an instruction to determine whether the one or more second video frames should be provided to the first machine-learned model; and chain-of-thought content comprising one or more example input-output pairs comprising one or more example outputs indicative of a determination that additional video frame input should be obtained.

In the example method, the first machine-learned model can include a model that was trained by obtaining a training dataset and performing a plurality of training iterations. In the example method, the training dataset can include a plurality of training examples. In the example method, each training example of the plurality of training examples can include a training input comprising one or more input video frames and one or more training outputs. In the example method, the training outputs can include data indicating whether additional video frame input should be obtained. In the example method, each of the plurality of training iterations can include providing, to the first machine-learned model, a respective training input of a respective training example of the plurality of training examples. In the example method, each of the plurality of training iterations can include generating, by the first machine-learned model, an inference output based on the respective training input. In the example method, each of the plurality of training iterations can include evaluating, based on a comparison between the inference output and a respective training output of the respective training example, an objective function. In the example method, each of the plurality of training iterations can include updating, based at least in part on the objective function, the first machine-learned model.

The example method can include receiving, by the computing system from the first machine-learned model, one or more first inference outputs. The example method can include storing, by the computing system in an inference storage data structure, the one or more first inference outputs.

In the example method, determining whether to provide the one or more second video frames to the first machine-learned model can include retrieving, by the computing system from the inference storage data structure, at least one first inference output of the one or more first inference outputs. In the example method, determining whether to provide the one or more second video frames to the first machine-learned model can include providing, by the computing system to the first machine-learned model or a second machine-learned model, the at least one first inference output. In the example method, determining whether to provide the one or more second video frames to the first machine-learned model can include receiving, by the computing system from the first machine-learned model or the second machine-learned model based on the at least one first inference output, data indicating whether the one or more second video frames should be provided to the first machine-learned model.

In the example method, the one or more first inference outputs can include data indicative of one or more identified positions of one or more objects depicted in the one or more first video frames.

In the example method, the first machine-learned model can include a multimodal model configured to process text and image data. In the example method, the one or more first inference outputs can include one or more image captions generated by the first machine-learned model based on the one or more first video frames.

In the example method, the one or more first video frames can be provided to the first machine-learned model at a first resolution. The example method can include determining, by the computing system based at least in part on the one or more first video frames, whether to provide the one or more second video frames to the first machine-learned model at a second resolution that is higher than the first resolution. In the example method, the one or more second video frames can be provided at the second resolution responsive to determining that the one or more second video frames should be provided at the second resolution.

In the example method, the computing system can include one or more server devices. The example method can include sending, by the one or more server devices to a client device, a request for the one or more second video frames. The example method can include receiving, by the one or more server devices from the client device, the one or more second video frames.

The example method can include receiving, by the computing system, a query. The example method can include providing, by the computing system, the query to the first machine-learned model. In the example method, the output can be generated based at least in part on the query.

In the example method, the one or more first video frames can be sampled in real time from streamed video data according to a first sampling rate. In the example method, the one or more first video frames can be provided to the first machine-learned model at a rate that is between 0.8 and 1.2 times the first sampling rate.

Example aspects of the present disclosure provide one or more example non-transitory computer-readable media storing instructions that are executable by one or more processors to cause a computing system to perform example operations. In some implementations, the example operations can include determining, based at least in part on one or more first video frames, whether to provide one or more second video frames to a first machine-learned model. The example operations can include providing, responsive to determining that the one or more second video frames should be provided to the first machine-learned model, the one or more second video frames to the first machine-learned model. The example operations can include generating, by the first machine-learned model based at least in part on the one or more second video frames, an output.

Example aspects of the present disclosure provide an example computing system that includes one or more processors and one or more example non-transitory computer-readable media storing instructions that are executable by one or more processors to cause a computing system to perform example operations. In some implementations, the example operations can include providing, to a first machine-learned model, one or more first portions of first time series data. The example operations can include determining, based at least in part on the one or more first portions, whether to provide one or more second portions of the first time series data to the first machine-learned model. The example operations can include providing, responsive to determining that the one or more second portions should be provided to the first machine-learned model, the one or more second portions to the first machine-learned model. The example operations can include generating, by the first machine-learned model based at least in part on the one or more second portions, an output.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system for adaptive frame sampling according to example implementations of some aspects of the present disclosure;

FIG. 2 is a block diagram of an example system for adaptive frame sampling according to example implementations of some aspects of the present disclosure;

FIG. 3 is a block diagram of an example system for adaptive frame sampling using a frame cache according to example implementations of some aspects of the present disclosure;

FIG. 4 is a block diagram of an example system for adaptive frame sampling according to example implementations of some aspects of the present disclosure;

FIG. 5 is a block diagram of an example system for adaptive frame sampling using stored inference values according to example implementations of some aspects of the present disclosure;

FIG. 6 is a block diagram of an example system for adaptive frame sampling in a client-server environment according to example implementations of some aspects of the present disclosure;

FIG. 7 is a block diagram of an example system for training a machine-learned model for adaptive frame sampling according to example implementations of some aspects of the present disclosure;

FIG. 8 is a flow chart diagram of an example method for adaptive frame sampling according to example implementations of some aspects of the present disclosure;

FIG. 9 is a flow chart diagram illustrating an example method for training a machine-learned model according to example implementations of aspects of the present disclosure;

FIG. 10 is a block diagram of an example processing flow for using machine-learned model(s) to process input(s) to generate output(s) according to example implementations of aspects of the present disclosure;

FIG. 11 is a block diagram of an example sequence processing model according to example implementations of aspects of the present disclosure;

FIG. 12 is a block diagram of an example technique for populating an example input sequence for processing by a sequence processing model according to example implementations of aspects of the present disclosure;

FIG. 13 is a block diagram of an example model development platform according to example implementations of aspects of the present disclosure;

FIG. 14 is a block diagram of an example training workflow for training a machine-learned model according to example implementations of aspects of the present disclosure;

FIG. 15 is a block diagram of an inference system for operating one or more machine-learned model(s) to perform inference according to example implementations of aspects of the present disclosure;

FIG. 16 is a block diagram of an example networked computing system according to example implementations of aspects of the present disclosure;

FIG. 17 is a block diagram of an example computing device according to example implementations of aspects of the present disclosure; and

FIG. 18 is a block diagram of an example computing device according to example implementations of aspects of the present disclosure.

### DETAILED DESCRIPTION

Generally, the present disclosure is directed to systems and methods for adaptive input sampling of time series data for machine-learned models, such as adaptive sampling of video frames from raw video data. For example, a computing system can provide one or more first video frames (or other first portions of an input time series) to a first machine-learned model, such as a small number of video frames sampled according to a low initial frame rate (e.g., ten frames per second, one frame per second, ten frames per minute, one frame per minute, etc.). Based in part on the one or more first video frames, the computing system can determine whether to provide one or more second video frames (or other second input portions) to the first machine-learned model, such as by increasing a sampling frame rate when sampling streamed video data, or by retrieving one or more second video frames from a video storage data structure. Responsive to determining that the one or more second video frames should be provided to the first machine-learned model, the computing system can provide the second video frames to the first machine-learned model, and the first machine-learned model can generate one or more inference outputs based on the provided (e.g., first and/or second) video frames.

In some instances, determining whether to provide the second video frames can include a machine-learned determination or a non-machine-learned determination. For example, in some instances, a computing system can determine whether to provide one or more second video frames (e.g., increase a sampling rate) based on one or more non-machine-learned metrics of change associated with a video segment, such as a metric of difference between pairs of frames (e.g., absolute pixel difference, etc.), a metric of motion (e.g., optical flow, etc.), and/or other metric of change (e.g., bitrate of a variable-bitrate compression method, etc.). As another example, in some instances, the one or more first frames can be provided to the first machine-learned model or another machine-learned model (e.g., a lightweight model for adaptive sampling determinations, etc.), and the machine-learned model can output data indicating whether the second frames should be sampled. Example outputs can include an output indicating that a framerate should be increased or decreased; an output identifying (e.g., by timestamp, etc.) one or more second video frames that should be provided; an output indicative of a machine-learned confidence level (e.g., based on the one or more first frames and one or more input queries, etc.); and/or other data indicating whether the second frames should be sampled. As another example, in some instances, the first machine-learned model or another machine-learned model can preprocess the one or more first frames to generate one or more intermediate inference outputs, such as a detailed frame caption; data identifying one or more objects in a first frame and their positions within the frame; or other intermediate outputs. In some instances, the intermediate outputs can be used for a machine-learned or non-machine-learned determination of whether to sample the second frames.

In some instances, machine-learned determination of whether to sample the second frames can include using a model that was trained (e.g., fine-tuned, etc.) to determine whether to sample the second frames, or using a model that was not trained on adaptive-frame-sampling data. For example, in some instances, a training dataset comprising one or more training examples can be obtained, wherein each training example can include one or more of: one or more training inputs, such as first frames or input queries; one or more training outputs, such as a ground truth response to an input query or a ground truth second-frame sampling output (e.g., timestamp associated with a second frame for answering an input query, etc.); and/or other training data, such as one or more second frames. An adaptive frame sampling model can then be trained based on the training dataset. As another example, in some instances, a machine-learned model can be prompted with in-context learning data to cause the machine-learned model to determine whether to sample the second video frames, such as instruction content instructing the machine-learned model to output a second-frame sampling determination; few-shot or chain-of-thought prompting content comprising one or more example input-output pairs or example thought processes comprising a second-frame sampling determination; or other in-context learning content.

An example architecture for machine-learned determination of whether to sample the second frames can include, for example, a machine-learned model comprising one or more foundation model layers (e.g., multimodal video language model layers, embedding layers, etc.) and one or more frame sampling determination layers (e.g., output layers, adapter layers, etc.) which interoperate with the one or more foundation model layers. In some instances, a frame sampling determination layer can include a layer having a token vocabulary (e.g., limited token vocabulary, etc.) comprising one or more specialized frame sampling tokens (e.g., sampling rate increase/decrease tokens, timestamp tokens, no-operation tokens indicating that a sampling rate should not be changed, etc.). In some instances, a sampling determination can include generating, based on the first frames and using one or more first layers (e.g., embedding layers, foundation model layers, etc.), a machine-learned embedding; and generating, based on the machine-learned embedding and using one or more second layers (e.g., output layers), one or more tokens indicating whether one or more second video frames should be sampled.

In some instances, the first and second video frames can include frames being streamed in real-time to the first machine-learned model for online processing, or frames that were captured in the past and stored using one or more non-transitory computer-readable media. In some instances, a system can include one or more real-time streaming and online processing components, along with a video cache (e.g., buffer, file, frame database, etc.) for storage and retrieval of second video frames that were not sampled in real time. In some instances, one or more characteristics of the video cache, such as timespan, framerate, or frame resolution, can be selected based on a tradeoff between an amount of data storage space available and an inference value of stored video data. As a non-limiting illustrative example, a computing system can include a video cache for storing N minutes (e.g., 15 minutes, etc.) of past video data at a first framerate; P minutes (e.g., 180 minutes, etc.) of past video data at a second framerate lower than the first framerate; and Q hours (e.g., 72 hours, etc.) of past frame data at a third framerate lower than the first framerate, where N, P, and Q can be real numbers. Other implementations are possible.

In some instances, in addition to adaptively determining a frame sampling rate, a computing system can adaptively determine a frame resolution at which the first or second frames should be provided to the first machine-learned model. For example, in some instances, the first frames can be provided at a low default resolution, and the computing system can determine whether to provide second frames at a different (e.g., higher) resolution compared to the default resolution; whether to provide higher-resolution copies of the first frames to the first machine-learned model; or other frame resolution determination.

In some instances, a machine-learned model (e.g., multimodal vision-language model, etc.) can process some or all of the first or second frames (e.g., in real-time, etc.) to generate one or more intermediate inference outputs, which can be stored in an inference cache. Example intermediate inference outputs can include, for example, caption data (e.g., detailed caption of one or more first frames, etc.); entity (e.g., object, person, animal, etc.) identification data (e.g., entity name, characteristics, position within frame, etc.); machine-learned embedding data (e.g., vector embeddings, key-value embeddings, etc.); or other intermediate inference data. In some instances, some or all of the intermediate inference outputs can be provided to the same or a different machine-learned model (e.g., responsive to an input query), and an inference output can be generated based at least in part on the intermediate inference outputs. Other implementations are possible.

In some instances, a sampling decision can be based on an input query (e.g., from a user) or not based on an input query. Additionally, in some instances, an input query can include a query directed to past video data (e.g., “Where did I leave my keys?”) or a query directed to future video data (e.g., “Please let me know when we arrive at the Union Station stop.”). In some instances, a sampling decision can include determining, based on a query, whether to increase or decrease a frame sampling rate, or to retrieve frame data from a video cache.

In some instances, a system that includes adaptive frame sampling can include a live digital assistant, such as a machine-learned digital assistant configured to receive live video data (e.g., responsive to a user activating a live video assistant feature, etc.) and respond to one or more user queries (e.g., requests, questions, etc.) based on the video data. In some instances, the machine-learned digital assistant can be a “situated” agent that has access to one or more perceptual inputs (e.g., video inputs, audio inputs, etc.) that at least partially correspond to a perceptual field of a user. For example, the video input can generally include at least a portion of the real-world surrounding the user. In some instances, a system that includes adaptive frame sampling can include a client-server system comprising one or more client devices (e.g., smart glasses, augmented reality headsets, smart phones, etc.), such as client devices configured to capture live video data, and one or more server devices. In some instances, the computing system can include one or more server-side machine-learned models (e.g., alone or in combination with one or more lightweight client-side models, etc.). In some instances, the client can transmit the one or more first frames to the server over a network, and can store all or part of a video cache on the client device. Responsive to a request for the second frames (e.g., request for increased sampling rate, request for cached video frames, etc.), the client device can transmit the second frames to the server device over a communication channel. In this manner, for instance, a volume of communication between client and server can be advantageously reduced (e.g., with little or no reduction in output quality of the live digital assistant, etc.) compared to some alternative implementations.

Systems and methods according to some aspects of the present disclosure can provide a variety of technical effects and benefits, such as reduced computational cost (e.g., electricity cost, processor usage, memory usage, etc.); reduced communication cost (e.g., network bandwidth usage, etc.); or improved technical performance compared to some alternative implementations.

For example, in some instances, systems and methods according to some aspects of the present disclosure can provide machine-learned inference at reduced computational cost compared to some alternative implementations. For example, in some instances, one or more first frames can be sampled at a low default frame rate and a low default resolution, thereby reducing a size of a sampled input compared to some alternative implementations. In some instances, a computational cost of machine-learned inference can be based at least in part on a size of an input context provided to the machine-learned model. As a non-limiting illustrative example, a computational cost of self-attention in a sequence processing model can in some instances be proportional to the square of a number of tokens in an input sequence provided to the model. Advantageously, systems and methods according to some aspects of the present disclosure can provide a reduced-size input by default, thereby reducing a cost of machine-learned inference in some instances (e.g., instances wherein the one or more first frames are sufficient to perform inference at high confidence, instances in which a rate of change associated with a video segment is low, etc.), while still remaining flexible enough to sample additional inputs when necessary.

As another example, in some instances, systems and methods according to some aspects of the present disclosure can provide reduced communication cost compared to some alternative implementations. For example, in some instances, a system can include a client-server system, wherein a client device transmits frame data over a network to a server system comprising a machine-learned model. By sampling first frames at a low default frame rate or low resolution, systems and methods according to the present disclosure can reduce an amount of data transmitted over the network, thereby improving the functioning of a client-server computing system.

As another example, in some instances, systems and methods according to some aspects of the present disclosure can provide improved technical performance at a given computational cost compared to some alternative implementations. For example, in some instances, systems and methods according to some aspects of the present disclosure can provide improved inference accuracy for a given input size by prioritizing more useful or higher-information input, and discarding less useful or lower-information input. As a non-limiting illustrative example, some alternative implementations may include systems configured to process video data at a fixed, medium framerate of N frames per second, thereby processing 60N frames per minute without regard to the relevance of any given frame with respect to a given inference. Continuing the non-limiting illustrative example, a system according to some aspects of the present disclosure, if provided an equivalent processing budget of 60N frames per minute, may sample 6N first frames at a rate of

$$\frac{N}{10}$$

frames per second, and may adaptively sample an additional 54N frames based on the value or importance of each frame to one or more inference tasks (e.g., responding to user queries, etc.), thereby sampling a greater number of high-importance or high-information input frames compared to some alternative implementations. In this manner, for instance, inference accuracy at a given computational cost can be improved compared to some alternative implementations.

As another example, in some instances, systems and methods according to some aspects of the present disclosure can provide improved peak technical performance (e.g., with respect to difficult tasks or high computational budgets) compared to some alternative implementations. For example, in some instances, an alternative implementation may include a maximum machine-learned frame processing rate that is lower than a maximum frame rate or maximum resolution of one or more video capture devices (e.g., because of limits on processing power, limits on data transmission bandwidth, client device battery power limits, or the like). Practical limits on machine-learned frame processing or data transmission may be particularly relevant in the case of some continuous-use live digital assistant use cases, where a user may wish to capture video data for minutes or hours and query a machine-learned model about events that may have happened minutes or hours ago. In such instances, some alternative implementations may cap a frame sampling rate at a rate that is below a maximum available frame rate. In contrast, systems and methods according to some aspects of the present disclosure can adaptively increase a frame sampling rate, or adaptively retrieve frames from a video cache, up to a maximum frame rate and frame resolution captured by a video capture device. By providing more detailed input context (e.g., more frames, higher frame resolution, etc.) in some instances (e.g., instances where inference is difficult, computational budget is high, or greater input detail is needed), systems and methods according to example aspects of the present disclosure can in some instances provide improved inference accuracy compared to some alternative methods.

Various example implementations are described herein with respect to the accompanying Figures.

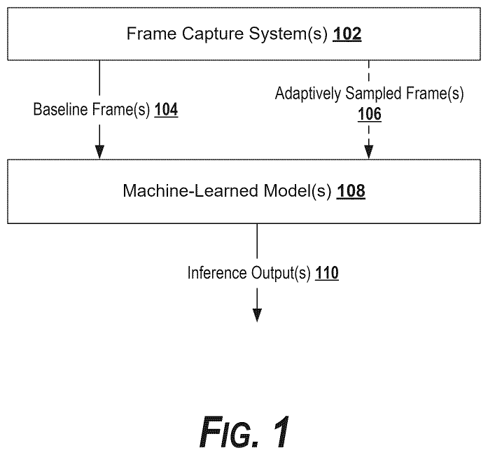

FIG. 1 is a block diagram of an example system for adaptive input sampling according to example implementations of some aspects of the present disclosure. A frame capture system 102 can provide one or more baseline frames 104 to one or more machine-learned models 108. Additionally, the frame capture system 102 or a computing system associated with the frame capture system 102 can determine whether to provide one or more adaptively sampled frames 106 to the machine-learned model(s) 108. Based on one or more of the baseline frame(s) 104 and adaptively sampled frame(s) 106, the machine-learned model 108 can generate an inference output 110.

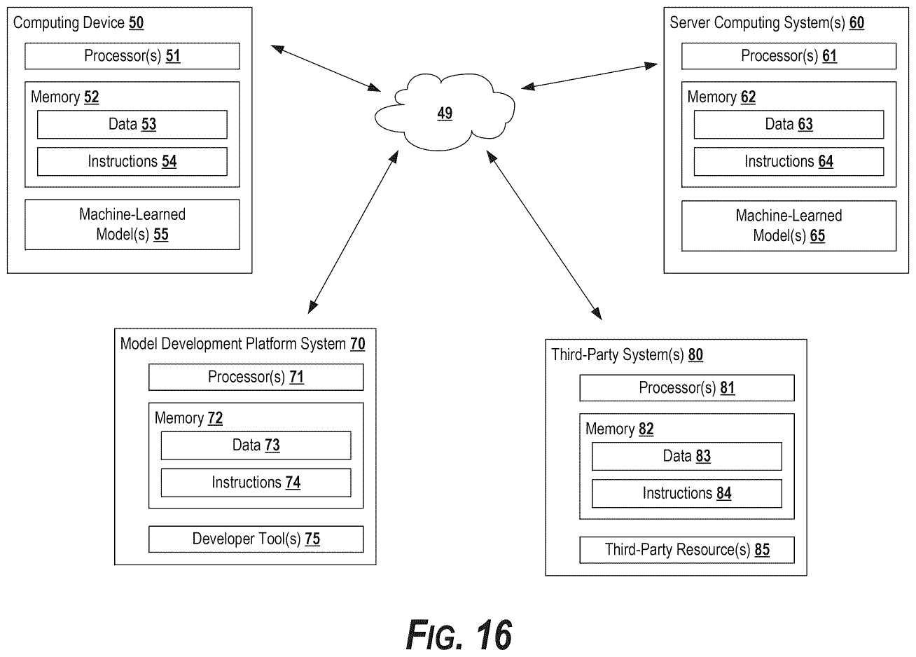

A frame capture system 102 can be or include one or more software, firmware, or hardware components configured to obtain (e.g., generate, retrieve, receive, etc.) one or more baseline frames 104 or adaptively sampled frames 106 and provide them to one or more machine-learned models 108. For example, in some instances, a frame capture system 102 can include one or more sensor components (e.g., camera components, imaging sensor components, etc.) configured to generate (e.g., capture, sense, etc.) one or more frames 104, 106; one or more non-transitory computer-readable media configured to store or retrieve frames 104, 106 (e.g., frame buffer associated with a display server or compositor, etc.); one or more input-output components configured to receive or retrieve video frames (e.g., from a camera, server device, display client of a display server or compositor, frame buffer, etc.); one or more processors (e.g., graphics processing units, etc.) for generating (e.g., rendering, compositing, etc.) frames 104, 106 or components thereof, or other components for providing frames 104, 106 to a machine-learned model 108. In some instances, the frame capture system 102 can be, comprise, be comprised by, or share one or more properties with a computing device or system described below with respect to FIGS. 16-18 (e.g., computing device 50, third-party system 80, computing device 98, computing device 99, etc.).

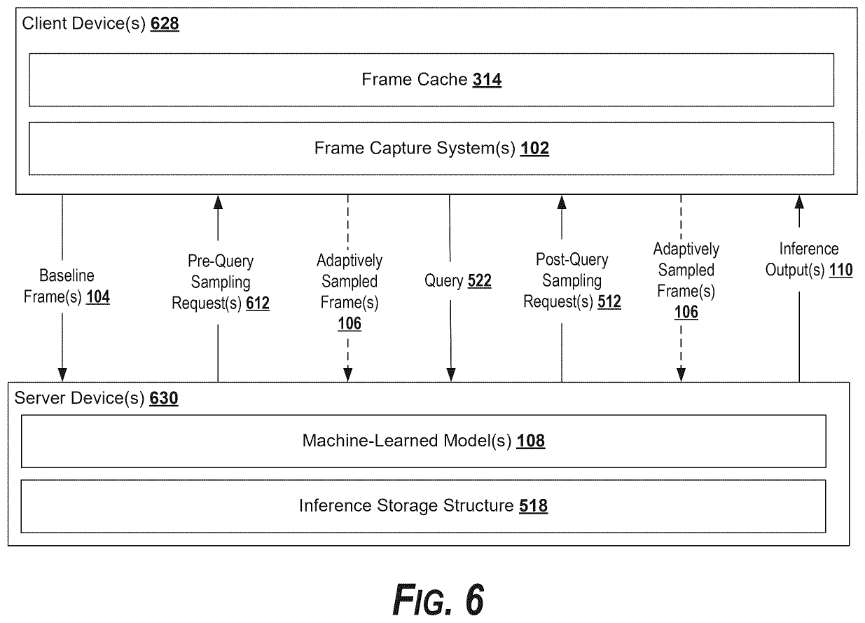

In some instances, a frame capture system 102 can include a client device in a client-server system, such as a mobile phone, smart glasses, augmented reality headset, wearable camera (e.g., helmet camera, chest-mounted clip-on camera, camera-equipped smart watch, etc.), laptop, desktop, or other client device. Further details of an example client-server system according to some aspects of the present disclosure are provided below with respect to FIG. 6. In some instances, a frame capture system 102 can include a vehicle-mounted device (e.g., dashboard camera, onboard computing system, etc.) or vehicle component (e.g., lidar component, camera component, or other sensor component, etc.); a robot-mounted device or robot component (e.g., camera component, sensor component, imaging component, etc.); or the like. In some instances, a frame capture system 102 can include one or more systems for providing stored video data (e.g., movies, YouTube videos, security camera footage, robot-mounted or vehicle-mounted video footage, etc.) or real-time video data (e.g., livestreamed video data from one or more internet-connected and camera-equipped frame capture systems 102, etc.) to one or more machine-learned models 108.

In some instances, a frame capture system 102 can be, comprise, be comprised by a device (e.g., client device, etc.) on which one or more machine-learned models 108 are installed or operating, or on a device that is different from or unrelated to a device (e.g., server device, etc.) on which one or more machine-learned models 108 are installed or operating.

Baseline frames 104 can generally include or otherwise represent various types of data. Baseline frames 104 can include one type or many different types of data.

Adaptively sampled frames 106 can generally include or otherwise represent various types of data. Adaptively sampled frames 106 can include one type or many different types of data. Adaptively sampled frames 106 can include data of the same type(s) or of different types of data as compared to baseline frames 104. In some instances, an adaptively sampled frame 106 can include data of the same type(s) or different type(s) compared to a corresponding baseline frame 104 used to determine whether the adaptively sampled frame 106 should be sampled.

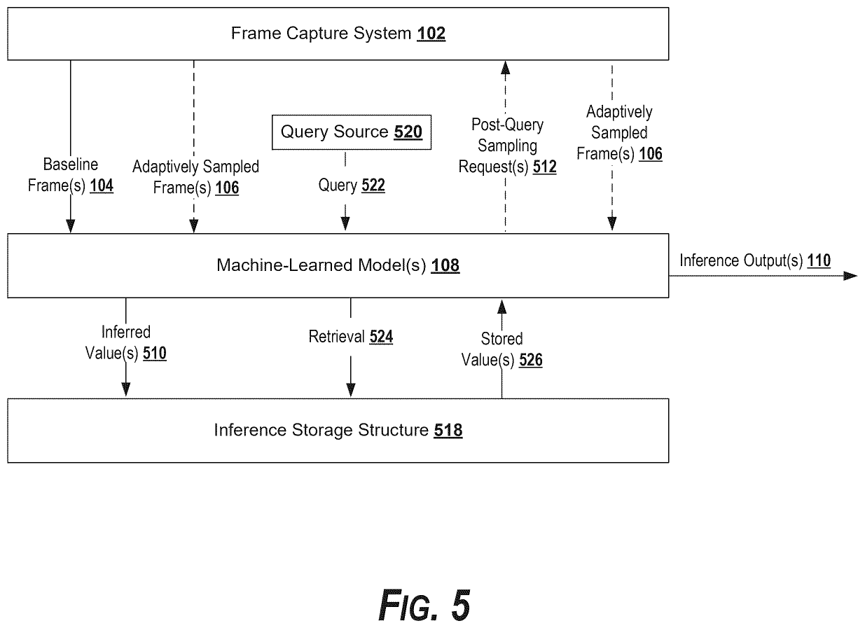

Example data types for baseline frames 104 or adaptively sampled frames 106 can include, for example, any time series data that can be separated into frames (e.g., segments, blocks, etc.). For example, in some instances, frames 104, 106 can include video frames; audio frames (e.g., frames of waveform or spectrogram data, such as mel spectrogram data; etc.); frames (e.g., segments, time windows, snapshots, etc.) associated with one or more other time series, such as time series of imaging data (e.g., functional magnetic resonance imaging data, etc.), sensor data (e.g., sensors collecting biological data, such as heart rate, heart rate variability, skin temperature, sleep data, activity level data such as step counts, blood oxygen saturation, cell movement, cell morphology, gene expression, protein interaction, drug response, stimuli response, luminescence, fluorescence, or absorbance sensors; data from sensors associated with a smartphone or smart watch, such as global positioning system (GPS) sensor, accelerometer, gyroscopic sensor or tilt sensor, physiological sensor, illuminance sensor, proximity sensor, ultraviolet index sensor, barometer, or other sensor; sensors collecting environmental data such as weather or climate data, air quality data such as pollutant concentration or other concentration data, water quality data, geological data, seismological data, or other environmental data; sensors collecting industrial or manufacturing data such as vibration, temperature, position, voltage, current, force, fluid flow rate or pressure, material composition, or other industrial sensors; etc.), or other time series data. In some instances, a frame 104, 106 comprising a video frame can include at least one image. In some instances, a frame 104, 106 comprising a video frame can include additional video frame data, such as audio data (e.g., audio data associated with a time period corresponding to the image); natural language data (e.g., text transcript data such as closed captioning, subtitle, or speech-to-text data); video frame metadata (e.g., timestamps; frame identifiers; image capture metadata such as frame rate, resolution, shutter speed, F1 values, geolocation data, camera identification data, and the like; machine-learned metadata such as one or more stored machine-learned inference values described below with respect to FIG. 5; etc.). In some instances, a frame 104, 106 can include one or more discrete time steps of discrete time series data (e.g., one 48,000th of a second of 48-kilohertz audio data, one sixtieth of a second of 60-frames-per-second video data, etc.), or can include one or more segments of continuous time series data (e.g., plurality of segments having a uniform length of time, such as 1-second segments, etc.). For example, in some instances, a frame 104, 106 can include a mel spectrogram frame comprising one or more “hops” (e.g., Fourier transform outputs, etc.) of mel spectrogram data, with each hop determined based on a plurality of raw audio sample datapoints (e.g., a number of audio sample datapoints equal to a fast Fourier transform length of the mel spectrogram, which may be the same as or different from a hop length of the mel spectrogram, etc.), wherein each audio sample datapoint comprises audio associated with a discrete time step (e.g., one 44,100th of a second for audio sampled at a 44.1 Khz sampling rate, etc.).

In some instances, a frame 104, 106 can include a frame (e.g., video frame, audio frame, etc.) to be provided (e.g., displayed, output, etc.) to a user of a computing device, such as a video frame to be displayed on a monitor or other display (e.g., television, etc.) associated with a computing device (e.g., gaming device, smartphone, augmented reality headset, etc.). As a non-limiting illustrative example, in some instances, a frame 104, 106 can include a rendered frame generated by a game executing on a computing device (e.g., video game executing on a personal computer, smartphone, video game console, or other device), and a rate of sampling for a machine-learned gaming assistant can be adaptively determined based on data indicative of an amount of action occurring during the game, a rate of change of a game state, a rate of motion of a user's avatar or rate of change of the user's visual field due to panning, or other relevant adaptive sampling data (e.g., as described below). Such data can in some instances be determined directly from the frames 104, 106 or from other data, such as game state data received from interacting with an application programming interface associated with the game; user input data (e.g., video game controller inputs, etc.) associated with the game; or other data sources.

In some instances, baseline frames 104 can include frames captured according to a low baseline sampling rate, such as a rate that is lower than a maximum framerate or lower than a framerate at which frame data (e.g., video data, etc.) is obtained by a frame capture system 102. As a non-limiting illustrative example, a frame capture system 102 may capture video data at 60 frames per second, and baseline frames 104 may include frame data sampled at a rate of one frame per second (e.g., every sixtieth frame, etc.), ten frames per second, or other sampling rate lower than 60 frames per second. In some instances, baseline frames 104 can include frames having a resolution (e.g., pixel count of image data of a video frame, sample rate in kilohertz of an audio segment associated with a video frame; compressed or uncompressed data size in bytes of any data type of a baseline frame 104, etc.) that is the same as or lower than a maximum available resolution or a resolution at which frame data is obtained by a frame capture system 102. In some instances, baseline frames 104 can include frames sampled in real-time according to a sampling rate (e.g., low baseline sampling rate), and can be provided to the machine-learned model 108 at a rate that is equal or approximately equal (e.g., between 0.8 and 1.2 times, etc.) the sampling rate.

Adaptively sampled frames 106 can include, for example, frames that are adaptively (e.g., optionally, based on a machine-learned or non-machine-learned sampling determination, etc.) provided to the machine-learned model(s) 108 according to one or more adaptive sampling determinations. In some instances, adaptively sampled frames 106 can include frames that are interleaved between the baseline frames 104 (e.g., in instances in which the baseline frames 104 are sampled according to a lower-than-maximum framerate, etc.). In some instances, adaptively sampled frames 106 can include frames associated with all or part of a time series, such as frames associated with a particular time-based subset of the time series (e.g., particular timestamp(s), particular time segment, etc.) or a plurality of frames associated with all of a time series (e.g., frames sampled from an entire time series according to an adaptive frame rate that is N times a baseline frame rate associated with the baseline frames 104, wherein N can be a real number greater than one).

In some instances, determining whether to provide one or more adaptively sampled frames 106 to a machine-learned model 108 can include selecting which frames to adaptively sample. Selecting adaptively sampled frames 106 can include, for example, selecting based on one or more timestamps associated with the adaptively sampled frames 106. In some instances, selecting adaptively sampled frames 106 can include selecting based on other data, such as stored metadata (e.g., stored machine-learned inferences, such as those discussed below with respect to FIGS. 5-6; frame identifier data; geolocation data; etc.) associated with the adaptively sampled frames 106, or based on any other appropriate data.

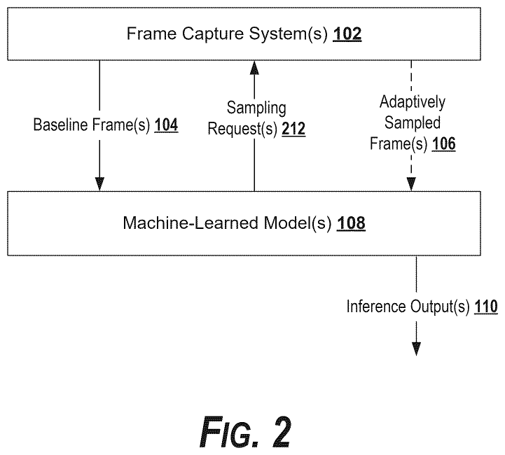

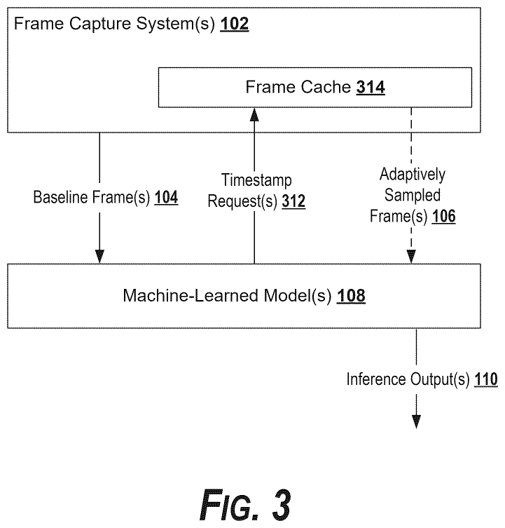

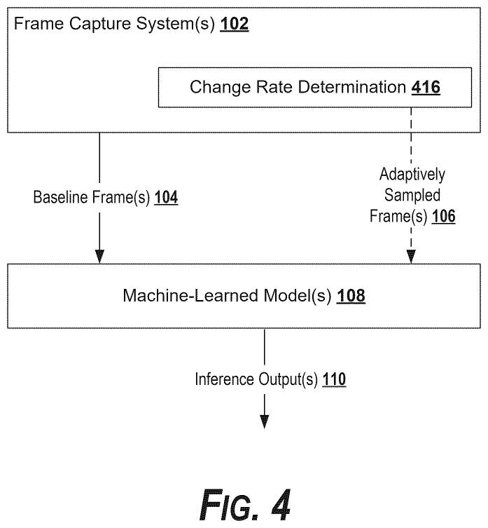

In some instances, determining whether to provide one or more adaptively sampled frames 106 to a machine-learned model 108 can include or not include one or more machine learning operations. For example, in some instances, a computing system can determine whether to provide one or more second video frames (e.g., increase a sampling rate) based on one or more non-machine-learned metrics of change associated with a video segment, such as a metric of difference between pairs of frames (e.g., absolute pixel difference, etc.), a metric of motion (e.g., optical flow, etc.), and/or other metric of change (e.g., bitrate of a variable-bitrate compression method, etc.). Further details of some example non-machine-learned adaptive sampling determinations are provided below with respect to FIG. 4. As another example, in some instances, the one or more first frames can be provided to the first machine-learned model or another machine-learned model (e.g., a lightweight model for adaptive sampling determinations, etc.), and the machine-learned model can output data indicating whether the second frames should be sampled. Further details of some example machine-learning-based adaptive sampling determinations are provided below with respect to FIGS. 2-3.

In some instances, frames 104, 106 can be sampled from one frame capture system 102 or a plurality of frame capture systems 102. As a non-limiting illustrative example, a machine-learned model 108 can receive baseline frames 104 from a plurality of frame capture systems 102, such as a plurality of frame capture systems 102 (e.g., plurality of robot-mounted sensors, etc.) that capture different viewing angles of a single scene; a plurality of frame capture systems 102 that capture a single location at different times; a plurality of frame capture systems 102 that capture different locations at the same time; or the like. Based on the baseline frames 104, a computing system (e.g., frame capture system 102, computing system comprising a machine-learned model 108, etc.) can determine whether to provide adaptively sampled frames 106 from some or all of the plurality of frame capture systems 102 to the machine-learned model 108; and a machine-learned model 108 can perform inference using the provided frames 104, 106.

In some instances, in addition to adaptively determining a frame sampling rate, a computing system can adaptively determine a frame resolution at which the first or second frames should be provided to the first machine-learned model. For example, in some instances, baseline frames 104 can be provided at a first (e.g., default, low, etc.) resolution, and a computing system can determine whether to provide adaptively sampled frames 106 having a higher, lower, or same resolution compared to the first resolution. In some instances, adaptively sampled frames 106 can include higher-resolution versions of one or more baseline frames 104, such as an adaptively sampled frame 106 corresponding to a same timestamp and viewing angle as a corresponding baseline frame 104, wherein the adaptively sampled frame 106 has a higher resolution than the corresponding baseline frame 104.

The machine-learned model(s) 108 can include one or more machine-learned models. The machine-learned model(s) 108 can include various model architectures, such as various neural network model architectures. An example model architecture for a machine-learned model(s) 108 can include a sequence processing model architecture (e.g., a transformer model). For example, the machine-learned model(s) 108 can be configured to receive an input sequence and generate an output sequence. For instance, the machine-learned model(s) 108 can be configured to generate an output sequence where elements of the output sequence are predicted based on the elements of the input sequence. In some instances, a machine-learned model 108 can include a model architecture having an attention mechanism (e.g., self-attention). In some instances, the machine-learned model 108 can be a pre-trained model (e.g., pretrained using large-scale unsupervised learning). In some instances, the machine-learned model 108 can be fine-tuned over one or more fine-tuning datasets, such as a fine-tuning dataset associated with one or more specialized generation tasks.

In some instances, a machine-learned model 108 can include a model configured to receive video data (e.g., video data comprising a plurality of video frames, image data comprising a plurality of images associated with video frames, etc.) as input and generate one or more outputs (e.g., machine-learned embedding vector outputs comprising a vector of machine-learned numerical outputs; natural language outputs such as text-based natural language outputs; video, audio, or other output data types; etc.) based on the video data. In some instances, a machine-learned model 108 can include a multimodal machine-learned model 108, such as a model configured to process both image and text data (e.g., image-to-text model such as a captioning model, visual question answering model, or the like); a multimodal model configured to process image data, audio data, and other data (e.g., text data, metadata, etc.) associated with a plurality of video frames; or other multimodal model.

In some instances, a machine-learned model 108 can include a variable-input-size architecture configured to receive and process inputs of a plurality of different input sizes (e.g., input lengths such as number of input frames, length of time associated with an input time series, etc.). In some instances, a machine-learned model 108 can include a variable-framerate architecture configured to receive and process inputs of a plurality of different frame rates (e.g., plurality of different lengths of time between consecutive frames, etc.). In some instances, a machine-learned model 108 can include a variable-resolution architecture configured to receive and process frames 104, 106 having a plurality of different input sizes (e.g., different number of bytes per frame 104, 106; different numbers of pixels, datapoints, or the like per frame 104, 106; etc.).

An inference output 110 can generally include or otherwise represent various types of data. An inference output 110 can include one type or many different types of data. Example inference outputs 110 can include, for example, natural language outputs (e.g., text-based natural language outputs, audio-based natural language outputs such as machine-generated speech outputs, etc.), machine-learned embedding outputs (e.g., vector embeddings comprising a plurality of numerical values, etc.), action selection outputs (e.g., computer code outputs such as calls to one or more application programming interfaces; other data indicative of an action selected by the machine-learned model 108 to be performed by a system associated with the machine-learned model 108, such as a text-based action selection output; etc.), machine-learned generative outputs (e.g., audio, video, or text generation outputs, etc.); classification outputs (e.g., Boolean outputs, classification based on a plurality of enumerated classes, etc.); or other machine-learned inference outputs.

In some instances, an inference output 110 can include an adaptive sampling determination output, such as an output identifying (e.g., by timestamp, etc.) one or more second video frames that should be provided; an output requesting a change (e.g., increase, decrease, etc.) in a sampling framerate, sampling resolution, or the like; an output indicative of a machine-learned confidence level (e.g., based on the one or more first frames and one or more input queries, etc.); or other data indicating whether the second frames should be sampled. As used herein, “sampling framerate” can refer to a number of frames 104, 106 provided to the machine-learned model 108 per time period (e.g., second, minute, etc.) of a time series associated with the frames 104, 106. As used herein, “sampling resolution” can refer to an amount of data (e.g., in bytes, pixels, etc.) provided to the machine-learned model 108 per frame 104, 106 provided to the machine-learned model 108. Further details of some example machine-learned adaptive sampling determinations according to some aspects of the present disclosure are provided below with respect to FIGS. 2-3.

FIG. 2 is a block diagram of an example system for adaptive input sampling according to example implementations of some aspects of the present disclosure. A frame capture system 102 can provide one or more baseline frames 104 to one or more machine-learned models 108. Based at least in part on the baseline frames 104, the machine-learned model 108 can determine whether to send a sampling request 212 to the frame capture system 102 requesting one or more adaptively sampled frames 106. Responsive to receiving a sampling request 212, the frame capture system 102 can provide one or more adaptively sampled frames 106 to the machine-learned model(s) 108. Based on one or more of the baseline frame(s) 104 and adaptively sampled frame(s) 106, the machine-learned model 108 can generate an inference output 110.

A sampling request 212 can be, for example, any data indicative of a request for one or more adaptively sampled frames 106 or otherwise indicating that one or more adaptively sampled frames 106 should be provided to a machine-learned model 108. A sampling request 212 can generally include or otherwise represent various types of data. A sampling request 212 can include one type or many different types of data. Example data types for a sampling request 212 can include token data (e.g., specialized tokens of a specialized token vocabulary for making sampling requests 212), natural language data, numerical data, computer code data (e.g., application programming interface (API) call data, etc.), text data (e.g., action selection text data associated with a machine-learned model 108 comprising a ReAct agent, such as an action selection to be interpreted by glue code of a computing system, etc.), timestamp data or other frame-related metadata, or other data types.

In some instances, a sampling request 212 can include one or more outputs (e.g., tokens, etc.) indicative of a request to adjust (e.g., raise, lower, double, halve, etc.) a sampling rate, such as data (e.g., numerical data, etc.) indicative of an adjusted sample framerate; data (e.g., numerical data, etc.) indicative of a sample framerate adjustment factor (e.g., numerical value by which a current sample framerate should be multiplied to generate an adjusted framerate, numerical value that should be added to a current sample framerate to generate an adjusted sample framerate, etc.); data (e.g., token data such as specialized token associated with an output token vocabulary, etc.) indicative of one or more predetermined sample framerate adjustment actions (e.g., multiply framerate by a predetermined real-numbered value associated with the token, such as 2.0, 0.5, or another value; increase or decrease framerate by a predetermined value associated with the token, such as one frame per second; or other adjustment action). In some instances, a sampling request 212 can include data (e.g., no-operation token, no-operation command, etc.) indicating that no adaptively sampled frames 106 should be provided to the machine-learned model 108 or indicating that no change should be made to a sampling framerate at which adaptively sampled frames 106 are being provided.

In some instances, a sampling request 212 can include data indicative of a requested sampling resolution, such as numerical data indicative of a selected number of pixels per adaptively sampled frame 106; data (e.g., numerical data, token data) indicative of an adjustment (e.g., adding, subtracting, dividing, or multiplying by a specified amount, etc.) to a sampling resolution; data indicating that no resolution adjustment should be made; or other data indicative of a requested sampling resolution.

In some instances, a sampling request 212 can include data indicative of which of a plurality of adaptively sampled frames 106 should be provided to the machine-learned model 108. Example types of data for indicating which adaptively sampled frames 106 should be provided can include timestamp data indicative of one adaptively sampled frame 106 or a plurality of adaptively sampled frames 106 (e.g., time range data, etc.); frame identifier data (e.g., numerical frame identifier, etc.) identifying one or more adaptively sampled frames 106; machine-learned embedding data (e.g., embedding comprising vector of numerical values, semantic embedding vector, etc.) for retrieving one or more adaptively sampled frames 106; index data or hash data for retrieving adaptively sampled frames 106; or other data identifying an adaptively sampled frame 106. In some instances, a sampling request 212 can include a machine-learned semantic embedding for retrieving one or more adaptively sampled frames 106 stored in association with a vector database (e.g., semantic embedding associated with one or more user queries, etc.). Further details of some example sampling requests 212 directed to specifically identified adaptively sampled frames 106 according to some aspects of the present disclosure are provided below with respect to FIG. 3.

In some instances, a sampling request 212 can include data indicative of a confidence level of a machine-learned model 108 (e.g., confidence level associated with one or more inferences of the machine-learned model 108, etc.). For example, in some instances, a plurality of baseline frames 104 can be provided to the machine-learned model 108; the machine-learned model 108 can generate one or more outputs (e.g., make one or more inferences, etc.) based on the baseline frames 104; and the machine-learned model 108 can output data (e.g., one or more numerical values, etc.) indicative of a confidence level associated with the output(s). For example, in some instances, a machine-learned model 108 can generate one or more probability distributions (e.g., softmax probability distributions, etc.) over a plurality of possible output values (e.g., token vocabulary, classification classes, or other output vocabulary), and a confidence level can be equal to a probability associated with one or more output values (e.g., output tokens, etc.) generated by the machine-learned model 108. In some instances, a confidence value can be compared to a confidence threshold, and additional adaptively sampled frames 106 can be provided if the confidence value is below the confidence threshold.

In some instances, a machine-learned determination of whether to send a sampling request 212 to the frame capture system 102 can be performed by a machine-learned model 108 that has been trained (e.g., fine-tuned, etc.) on adaptive sampling determination data, or a general-purpose machine-learned model 108 that has not been trained on adaptive sampling determination data. In some instances, performing adaptive sampling determination with a fine-tuned model can include providing a machine-learned model 108 with one or more inputs (e.g., baseline frames 104, user queries, etc.), and generating one or more sampling requests 212 (e.g., sampling request tokens of a specialized token vocabulary, etc.) based on the inputs. For example, in some instances, a machine-learned model 108 can include one or more layers configured to process a variable number of frames as part of a “prefill” process (e.g., encoding process associated with a self-attention mechanism, etc.), and to generate one or more inference outputs 110 based on one or more encoded values determined during the prefill process (e.g., according to an autoregressive decoding process, etc.). In some instances, the machine-learned model 108 can further include one or more layers configured to output one or more sampling requests 212 based on one or more encoded values determined during the prefill process. In some instances, a plurality of baseline frames 104 can be provided to the machine-learned model 108; the machine-learned model 108 can encode the baseline frames 104 according to a prefill process (e.g., using one or more attention heads, etc.); and the machine-learned model 108 can generate one or more sampling request 212 outputs based on one or more embeddings generated based on the baseline frames 104 during the prefill process. In some instances, adaptively sampled frames 106 can be provided to the machine-learned model 108; the machine-learned model 108 can further encode the adaptively sampled frames 106; and can generate one or more sampling requests 212 based on the encodings (e.g., based in part on encodings of the adaptively sampled frames 106 and in part on encodings of the baseline frames 104, etc.). In some instances, the machine-learned model 108 can periodically generate one or more sampling requests 212 (e.g., as part of a real-time inference system for processing streamed video data, etc.). In some instances, the sampling requests 212 can be interspersed with one or more inference outputs 110, which can be generated periodically, on-demand (e.g., responsive to a user query, etc.), or in another manner. In some instances, the machine-learned model 108 can iteratively generate one or more sampling requests 212; process adaptively sampled frames 106 received responsive to the sampling requests 212; and generate additional sampling requests 212 based on the adaptively sampled frames 106, repeating the process until a process endpoint is reached (e.g., until a no-operation sampling request 212 is output, until a predetermined time, etc.), at which point the machine-learned model 108 can generate one or more inference outputs 110 (e.g., based at least in part on the adaptively sampled frames 106 and baseline frames 104 processed by the machine-learned model 108, etc.). Other implementations are possible.

In some instances, a machine-learned model 108 that generates a sampling request 212 can be the same as or different from a machine-learned model 108 that generates one or more inference outputs 110. For example, in some instances, a lightweight sampling determination model (e.g., lower-computational-cost or lower-parameter-count compared to a model for generating inference outputs 110, etc.) can generate one or more sampling requests 212 without generating inference outputs 110. As another example, in some instances, a machine-learned model 108 comprising one or more embedding layers can generate one or more first embeddings based on the baseline frames 104 or adaptively sampled frames 106, and the sampling requests 212 and inference outputs 110 can each be based on the first embeddings of similar (e.g., same) sets of frames 104, 106. In some instances, the sampling requests 212 can be generated by one or more first output layers based on the first embeddings, and the inference outputs 110 can be generated by one or more second output layers based on the first embeddings, wherein the first output layers can be the same as or different from the second output layers. For example, in some instances, a machine-learned model 108 can include a plurality of embedding layers; one or more first output layers for generating sampling requests 212 based on the embeddings; and one or more second output layers for generating inference outputs 110 based on the embeddings. In this manner, for instance, one or more embedding layers can be shared between a machine-learned model 108 for sampling request 212 determination model and a corresponding machine-learned model 108 for inference output 110 generation. In some instances, frames 104, 106 can be provided to the one or more embedding layers; one or more outputs of the embedding layers can be precomputed (e.g., according to a prefill process, etc.) and stored (e.g., in a prefill cache, key-value cache, in volatile memory, etc.) for usage in both sampling request 212 determination by the first output layers and inference output 110 generation by the second output layers. In some instances, first output layers can have an output vocabulary (e.g., token vocabulary, etc.) that is the same as or different from the second output layers. For example, in some instances, the first output layers can be configured to output only sampling determination tokens associated with a specialized token vocabulary for adaptive sampling determination (e.g., tokens requesting a framerate increase, framerate decrease, framerate doubling or halving, resolution increase or decrease, resolution doubling or halving, or the like; tokens requesting specific adaptively sampled frames 106, such as adaptively sampled frames 106 associated with a specific timestamp; or other sampling determination tokens).

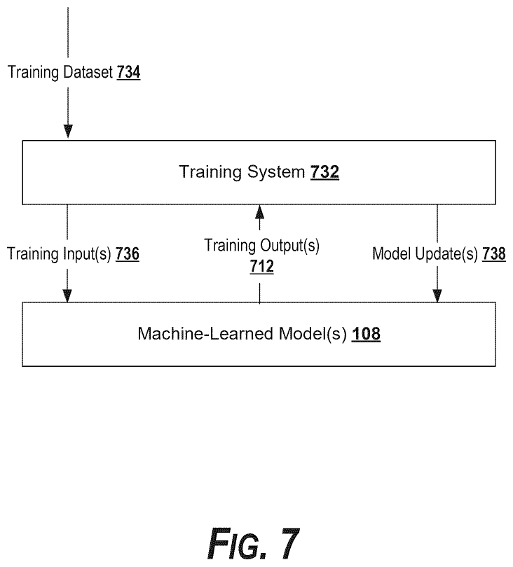

In some instances, a machine-learned model 108 can include a model that has been fine-tuned on adaptive sampling determination data. Further details of some example methods for fine-tuning a machine-learned model 108 on adaptive sampling determination data according to some aspects of the present disclosure are provided below with respect to FIG. 7.

In some instances, a machine-learned adaptive sampling determination can be performed using a general-purpose machine-learned model 108 that has not been fine-tuned on adaptive sampling determination data. For example, in some instances, the machine-learned model 108 can be provided with input context, and the machine-learned model 108 can generate one or more sampling requests 212 based on the input context. In some instances, the input context can include in-context learning data configured to cause the machine-learned model 108 to output a sampling request 212 indicative of one or more adaptively sampled frames 106 to be provided to the machine-learned model 108. In some instances, in-context learning data can include instruction content (e.g., natural language instruction content, etc.) instructing the machine-learned model 108 to determine whether one or more adaptively sampled frames 106 are needed (e.g., to respond to a user query included in the input context, etc.) and to generate an output indicative of an adaptive sampling determination.

In some instances, in-context learning content can include prompting content associated with various prompting techniques, such as few-shot prompting, chain-of-thought prompting (e.g., thought-observation-action prompting, etc.), least-to-most prompting, self-critique, or the like. For example, in some instances, an agent can be prompted with a plurality of example input-output pairs associated with a plurality of example adaptive sampling determinations; a plurality of example input-reasoning-output triplets or reasoning-output pairs associated with a plurality of example adaptive sampling determinations; or other in-context learning content. In some instances, an input of a tuplet (e.g., input-output pair, input-reasoning-output triplet, etc.) comprising an example input can include an example query (e.g., prompt, user query, input value, natural language query, etc.); one or more example baseline frames 104 or other data associated with example baseline frames 104 (e.g., inference outputs 110 generated from example baseline frames 104, such as caption data, object detection data, object position data, etc.; embedding data; frame identifier data; etc.); or other input content. In some instances, an example output of an in-context learning tuplet can include an example sampling determination output, such as an example sampling request 212. In some instances, the example sampling determination output can have any property described above with request to a sampling request 212.

In some instances, an input-reasoning-output or reasoning-output tuplet can include one or more example reasoning outputs (e.g., intermediate outputs associated with a chain-of-thought reasoning chain, etc.) associated with one or more example outputs. As a non-limiting illustrative example, some example reasoning outputs can include example confidence level data generated by a machine-learned model 108 or provided by a human annotator; data inferred from one or more example input frames 104, 106, such as data indicative of one or more entities associated with (e.g., identified in) or not associated with an example input of an input-reasoning-output tuplet (e.g., “Basketball identified in existing frames? No.” etc.), relationships between entities associated with an example input, other properties of an example input (e.g., metadata of a frame 104, 106, etc.), facts or beliefs determined based on content of an example input (e.g., example frame 104, 106 of an input-reasoning-output tuplet, etc.), or other reasoning data. In some instances, a reasoning-output tuplet can be included in in-context learning data, wherein the reasoning and output are associated with an example input (e.g., past input frame 104, 106, etc.) that is not provided as part of the in-context learning content. For example, in some instances, in-context learning content can include chain-of-thought content that lacks one or more input frames 104, 106 associated with the chain-of-thought content. In some instances, each example thought process can include a plurality of delimiters configured to mark each part of the example thought process (e.g., “[Thought],” “[Act],” “[Observe]”; “input:”, “framerate choice:”, “resolution choice:”; “1” “2” “3”; etc.). An example thought process can include, for example, one or more frame analysis components; one or more sampling determination components; or other components.

In some instances, an example chain-of-thought prompt can include an adaptive sampling determination component comprising an instruction for providing a sampling request 212 to a frame capture system 102 (e.g., “[Act]: sampleFrame=11:33:07 p.m.”; <sampleRequest>frameRateMultiplier=2.0″); etc.). In some instances, an example instruction can be in a structured or standardized format, such as a structured or standardized format associated with a request space comprising one or more sampling requests 212. In some instances, a structured or standardized format can include a format (e.g., syntax, etc.) associated with a computer coding language (e.g., Python, C, etc.); a format associated with an application programming interface (API), a structure associated with a markup language or object notation language (e.g., extensible Markup Language (XML), JavaScript Object Notation (JSON), etc.), a structure associated with a pseudocode or interpretable instruction set (e.g., pseudocode or sampling request 212 format to be interpreted by glue code associated with the machine-learned model 108, etc.), or other structure (e.g., comma-separated value, etc.). In some instances, an example instruction of in-context learning content can have any property described herein with respect to a sampling request 212, or vice versa.

In some instances, the machine-learned model 108 can generate, based on in-context-learning content, data indicative of a sampling request 212; a computing system associated with the machine-learned model 108 can provide a corresponding sampling request 212 to a frame capture system 102; the frame capture system 102 can provide adaptively sampled frames 106 to the machine-learned model 108 based on the sampling request 212; and the machine-learned model 108 can generate an inference output 110 based at least in part on the adaptively sampled frames.

FIG. 3 is a block diagram of an example system for adaptive input sampling using a frame cache according to example implementations of some aspects of the present disclosure. A frame capture system 102 can provide one or more baseline frames 104 to one or more machine-learned models 108. Additionally, the frame capture system 102 can store one or more additional frames in a frame cache 314. Based at least in part on the baseline frames 104, the machine-learned model 108 can determine whether to send a timestamp request 312 to the frame capture system 102 requesting one or more adaptively sampled frames 106 associated with one or more timestamps. Responsive to receiving a timestamp request 312, the frame capture system 102 can retrieve one or more adaptively sampled frames 106 associated with the timestamp from the frame cache 314 and provide the adaptively sampled frame(s) 106 to the machine-learned model(s) 108. Based on one or more of the baseline frame(s) 104 and adaptively sampled frame(s) 106, the machine-learned model 108 can generate an inference output 110.

A timestamp request 312 can be, comprise, be comprised by, or otherwise share one or more properties with a sampling request 212. For example, in some instances, a timestamp request 312 can have any property described above with respect to a sampling request 212, or vice versa. A timestamp request 312 can include data indicative of which of a plurality of adaptively sampled frames 106 should be provided to the machine-learned model 108. Example types of data for indicating which adaptively sampled frames 106 should be provided can include timestamp data indicative of one adaptively sampled frame 106 or a plurality of adaptively sampled frames 106 (e.g., time range data, etc.); frame identifier data (e.g., numerical frame identifier, etc.) identifying one or more adaptively sampled frames 106; machine-learned embedding data (e.g., embedding comprising vector of numerical values, semantic embedding vector, etc.) for retrieving one or more adaptively sampled frames 106; index data or hash data for retrieving adaptively sampled frames 106; or other data identifying an adaptively sampled frame 106.

In some instances, a timestamp request 312 can include data indicative of one or more times (e.g., time range associated with a plurality of adaptively sampled frames 106, exact timestamp of one adaptively sampled frame 106, etc.) of one or more adaptively sampled frames 106 to be provided to the machine-learned model 108, and the adaptively sampled frames 106 can be retrieved from the frame cache 314 based on the time data. However, other implementations are possible without deviating from the scope of the present disclosure. For example, in some instances, a timestamp request 312 or sampling request 212 can include embedding data (e.g., machine-learned vector embedding data generated by a machine-learned model 108, such as a machine-learned embedding of: a user query, an entity associated with a user query or depicted in a baseline frame 104, etc.), and the adaptively sampled frames 106 can be retrieved from the frame cache 314 based on the embedding data (e.g., using a vector database, etc.). As another example, in some instances, a timestamp request 312 or sampling request 212 can include keyword data, hash data, numerical identifier data, frame metadata (e.g., geolocation metadata, etc.), or other data identifying one or more adaptively sampled frames 106, and the adaptively sampled frames 106 can be retrieved from the frame cache 314 based on the data (e.g., according to an index relating the data to one or more corresponding adaptively sampled frames 106, etc.).

In some instances, a timestamp request 312 can include additional data, such as a sampling framerate at which adaptively sampled frames 106 should be sampled from a time range; a sampling resolution; or other additional data. In some instances, a timestamp request 312 can include cropping data, such as bounding box data defining a cropped portion of an adaptively sampled frame 106 that should be provided to the machine-learned model 108. For example, in some instances, a timestamp request 312 can include a request for a higher-resolution or “zoomed in” portion of an adaptively sampled frame, wherein the request can comprise resolution data defining a resolution at which a cropped portion of an adaptively sampled frame 106 should be provided and cropping data (e.g., bounding box data, pixel location data identifying a center of the cropped portion, etc.) identifying the cropped portion. However, this is not required. For example, in some instances, a timestamp request 312 can include a portion of an adaptively sampled frame 106 that is provided at the same resolution or a lower resolution compared to a baseline resolution of a baseline frame 104.

A frame cache 314 can include, for example, one or more software, firmware, or hardware components for storing one or more frames 104, 106 using one or more non-transitory computer-readable media. In some instances, a frame cache 314 can include one or more data structures for storing frames 104, 106, such as files (e.g., video files, etc.), memory pages, buffers, databases, tables, rows, columns, objects of an object-oriented programming language, objects of a NoSQL database, structs, collections, or other data structures. For example, in some instances, a frame cache 314 can include a file (e.g., video file) having a file format configured to provide efficient retrieval (e.g., O(1) or constant-time retrieval) of adaptively sampled frames 106 based on timestamp data. As another example, a frame cache 314 can include a data structure (e.g., database data structure, etc.) providing efficient retrieval (e.g., O(1) or constant-time retrieval, O(log(frame count)) retrieval, etc.) of frames 104, 106 based on other timestamp request 312 data, such as a vector database configured to efficiently retrieve adaptively sampled frames 106 based on vector embeddings associated with the adaptively sampled frames 106 (e.g., based on a vector index) or another database configured to efficiently retrieve adaptively sampled frames 106 (e.g., based on an index associated with timestamp request data 312).

In some instances, a frame capture system 102 can obtain frames 104, 106 (e.g., using a camera device, etc.) and add the frames 104, 106 to the frame cache 314 as they are obtained (e.g., in real time, etc.). However, this is not required. For example, in some instances, a frame cache 314 can include pre-existing or static frame 104, 106 data, such as one or more pre-existing video files (e.g., movies, YouTube videos, security camera videos, etc.)

In some instances, a frame cache 314 can include a data structure having a finite size (e.g., predetermined fixed size, etc.), and the frame capture system 102 can remove (e.g., periodically remove, remove responsive to obtaining a new frame 104, 106 to add to the cache, etc.) one or more frames 104, 106 as appropriate. In some instances, the frames 104, 106 can be removed (e.g., deleted, etc.) from the cache according to a predetermined schedule. For example, in some instances, a frame cache 314 can include a buffer having a fixed number of frames or other fixed data size (e.g., fixed data size in bytes, etc.), and one or more oldest frames in the buffer can be deleted as the buffer is filled. In some instances, frames 104, 106 to be deleted can include all frames 104, 106 associated with a time range, or a subset of frames 104, 106 associated with the time range. As a non-limiting illustrative example, a frame capture system 102 can include a frame cache 314 configured to store N minutes (e.g., the most recent 15 minutes, etc.) of video data at a first framerate (e.g., thirty frames per second, etc.); the next most recent P minutes (e.g., 180 minutes, etc.) of video data at a second framerate lower than the first framerate (e.g., five frames per second, etc.); and Q hours (e.g., 72 hours, etc.) of past frame data at a third framerate lower than the first framerate (e.g., 10 frames per minute, etc.), where N, P, and Q can be real numbers. In such instances, the computing system can periodically (e.g., once per minute, once per second, etc.) remove a percentage of stored frames that are N+1 minutes old, such that frames older than N minutes old are now stored at the second framerate. For example, if the first framerate is thirty frames per second and the second frame rate is five frames per second, a frame capture system 102 could keep every sixth frame (wherein six is the ratio of the first framerate to the second framerate) associated with the N+1th minute, and remove the remaining frames associated with the N+1th minute from the frame cache 314.

In some instances, a frame cache 314 can store frames 104, 106 at a single resolution or at a plurality of resolutions. For example, in some instances, more recent frames 104, 106 (e.g., the most recent N minutes' worth of frames, etc.) can be stored at a first higher resolution, and less recent frames can be stored at a second resolution lower than the first resolution, or a third resolution lower than the second resolution, and so on. In some instances, the frame capture system 102 can downsample (e.g., periodically downsample, etc.) one or more frames 104, 106 (e.g., frames 104, 106 having an age above a predetermined frame age threshold, etc.) to generate one or more lower-resolution downsampled frames; remove the original frames 104, 106 from the frame cache 314; and add the downsampled frames to the frame cache 314. Other implementations are possible.

In some instances, a frame capture system 102 can retain or remove frames 104, 106 from a frame cache 314 based on factors other than time. For example, in some instances, a frame cache 314 can retain, remove, or downsample frames 104, 106 based at least in part on data indicative of one or more past retrievals of the frames 104, 106. For example, in some instances, a frame 104, 106 can be retained, removed, or downsampled based on one or more of: a frequency of retrieval of the frame 104, 106 during a past time period (e.g., most recent N minutes, etc.); a length of time that has passed since the frame 104, 106 was last retrieved from the frame cache 314; an estimated likelihood (e.g., machine-learned estimate, etc.) of future retrieval of the frame 104, 106 from the frame cache 314; or other retrieval data. In some instances, a frame 104, 106 can be retained, removed, or downsampled based at least in part on data indicative of information contained in the frame 104, 106, such as data indicative of a rate of change associated with the frame 104, 106 (e.g., data obtained using a change rate determination system 416 as described below with respect to FIG. 4, etc.), data indicative of an amount of difference between the frame 104, 106 and one or more other frames 104, 106 (e.g., neighboring frames 104, 106, etc.) of the frame cache 314; data indicative of an estimated importance of the frame 104, 106 to one or more machine-learned inference operations; frame metadata indicative of information contained in the frame 104, 106; or other frame data.

In some instances, a frame capture system 102 can retain, remove, or downsample frames 104, 106 based at least in part on whether the frames have been provided to one or more machine-learned models 108. As a non-limiting illustrative example, some frame capture systems 102 according to some aspects of the present disclosure may remove some or all frames 104, 106 provided to the machine-learned model 108 from the cache 314 after providing the frames 104, 106 to the machine-learned model 108. For example, in some instances, a machine-learned model 108 or computing system (e.g., server system, etc.) may retain data (e.g., prefill data, inference output 110 data, etc.) indicative of frames 104, 106 already provided to the machine-learned model 108, and may not be configured to reuse the frames 104, 106 at a later time. In such instances, the provided frames 104, 106 may be safely removed from the frame cache 314 upon providing the frames 104, 106 to the machine-learned model 108. Other implementations are possible.

FIG. 4 is a block diagram of an example system for adaptive input sampling according to example implementations of some aspects of the present disclosure. A frame capture system 102 can provide one or more baseline frames 104 to one or more machine-learned models 108. Additionally, the frame capture system 102 or a computing system associated with the frame capture system 102 can determine, based at least in part on a change rate determination 416, whether to provide one or more adaptively sampled frames 106 to the machine-learned model(s) 108. Based on one or more of the baseline frame(s) 104 and adaptively sampled frame(s) 106, the machine-learned model 108 can generate an inference output 110.

A change rate determination system 416 can be or include one or more software, firmware, or hardware components configured to obtain (e.g., determine, generate, retrieve, receive, etc.) data indicative of a rate of change associated with a plurality of frames 104, 106. In some instances, a change rate determination system 416 can be, comprise, be comprised by, or otherwise share one or more properties with the frame capture system 102 or may be associated with a system that is different from the frame capture system 102. In some instances, the change rate determination system 416 can be, comprise, be comprised by, or share one or more properties with a computing device or system described below with respect to FIGS. 16-18 (e.g., computing device 50, third-party system 80, computing device 98, computing device 99, etc.).

In some instances, data indicative of a rate of change can include data indicative of an amount of difference between two or more frames, such as an absolute pixel difference; a difference in object identification data (e.g., number or identity of entities depicted in the frames, position or relationship of entities depicted in the frames, etc.); or other metric of difference. In some instances, data indicative of an amount of difference can include data indicative of a difference between one or more inference outputs 110 (e.g., inferred values 510 as described below with respect to FIG. 5) generated based on the frames 104, 106, such as a difference between entities identified in the frames 104, 106, a difference in properties (e.g., position, etc.) of the identified entities, a difference (e.g., edit distance, semantic distance such as cosine distance between embeddings, etc.) between captions generated based on the frames, or the like. In some instances, data indicative of a rate of change can include data indicative of an amount of motion depicted in one or more frames 104, 106, such as an optical flow metric. In some instances, data indicative of a rate of change can include data associated with a compression method (e.g., preexisting or known compression algorithm, novel compression algorithm, etc.), such as a bitrate (e.g., number of bits used to represent each frame 104, 106, etc.) associated with a variable-bitrate compression algorithm. In this manner, for instance, a computing system can perform an adaptive sampling determination based on one or more baseline frames 104 by determining a rate of change associated with the baseline frames 104, and determining whether to sample one or more adaptively sampled frames 106 based on the rate of change.

In some instances, a frame capture system 102 can select a number of frames 104, 106 (e.g., number of frames per second, etc.) to provide to the machine-learned model 108 based on the data indicative of the rate of change. For example, in some instances, a frame capture system 102 can select a number of frames 104, 106 that is proportional to a metric of change (e.g., according to a ratio, etc.). As a non-limiting illustrative example, in some instances, a frame capture system 102 can provide at least one frame 104, 106 to the machine-learned model 108 for every X bits used to represent a video segment according to a variable-bitrate compression algorithm, wherein X can be a positive integer. In some instances, a frame capture system 102 can determine whether to provide one or more adaptively sampled frames 106 based on a comparison between a metric of change and one or more change rate thresholds (e.g., static or predetermined thresholds, dynamic or adaptive thresholds, etc.). For example, in some instances, baseline frames 104 can be provided to the machine-learned model 108 (e.g., according to a baseline sampling framerate), without providing adaptively sampled frames 106, when a metric of change is below a first threshold. Continuing the example, when the metric of change is above the first threshold, baseline frames 104 and adaptively sampled frames 106 can both be provided to the machine learned model 108 (e.g., according to a second sampling framerate higher than the baseline sampling framerate, etc.) until the metric of change drops back below the first threshold. In some instances, a frame capture system 102 can use one threshold or a plurality of change rate thresholds to determine a sampling framerate.

In some instances, a change rate threshold can include a static threshold or a dynamic or adaptive threshold. For example, in some instances, a threshold value associated with an adaptive change rate threshold can be determined based on one or more of: an amount of computing resources (e.g., memory, processor time, communication bandwidth, etc.) available for use with the machine-learned model 108; one or more configuration settings (e.g., user settings such as battery saver settings, configuration settings of a frame capture system 102, etc.); data indicative of whether a user query has recently been received or whether a user query is likely to be received soon (e.g., whether a mobile phone screen has been unlocked, whether a user has said “Hey Google” or otherwise interacted with a mobile digital assistant, etc.); or other relevant data.

FIG. 5 is a block diagram of an example system for adaptive input sampling using stored inference values according to example implementations of some aspects of the present disclosure. One or more machine-learned models 108 can generate, based on one or more baseline frames 104 or adaptively sampled frames 106, one or more inferred values 510, which can be stored in an inference storage structure 518 for later use. Subsequently, the machine-learned model can receive a query 522 from a query source 520, such as a user. Based at least in part on the query 522, the machine-learned model 108 can perform or request a retrieval 524 from the inference storage structure 518 to obtain one or more stored values 526. Additionally or alternatively, the machine-learned model 108 can send, based at least in part on the query 522 or stored values 526, one or more post-query sampling requests 512 to the frame capture system 102. Responsive to receiving the one or more post-query sampling requests 512, the frame capture system 102 can provide one or more adaptively sampled frames 106 to the machine-learned model(s) 108. Based at least in part on one or more of the query 522, the baseline frames 104, the adaptively sampled frames 106, and the stored values 526, the machine-learned model 108 can generate one or more inference outputs 110.

In some instances, an inferred value 510 can be, comprise, be comprised by, or otherwise share one or more properties with an inference output 110. For example, in some instances, an inferred value 510 can have any property described herein with respect to an inference output 110, and vice versa. In some instances, inferred values 510 stored in an inference storage structure 518 can include one or more data types that are the same as or different from one or more data types of an inference output 110 that is not stored in the inference storage structure 518 (e.g., inference output 110 provided to a user or another computing device, etc.); can be generated according to a process that is the same as or different from a method for generating other inference outputs 110; or can be generated using one or more machine-learned models 108 that are the same as or different from a machine-learned model 108 used to generate other inference outputs 110.

For example, in some instances, an inferred value 510 stored in an inference storage structure 518 can include one or more intermediate inferred values 510 generated by a first machine-learned model 108. In some instances, the one or more intermediate inferred values 510 can be provided to the first or a second machine-learned model 108, and the machine-learned model 108 can generate an inference output 110 based at least in part on the intermediate inferred values 510. For example, in some instances, a first machine-learned model 108 can include a vision-language model configured to generate one or more natural language outputs (e.g., captions, etc.) based on one or more frames 104, 106. For example, in some instances, a first machine-learned model 108 can be configured to generate caption data (e.g., detailed natural language caption, etc.) describing one or more baseline frames 104 (e.g., without regard to any query 522). In some instances, a second machine-learned model 108 can include a model (e.g., vision language model, large language model, visual question answering model, etc.) configured to generate an inference output 110 based at least in part on one or more captions or other inferred values 510.

An inferred value 510 can include one type or many types of data. In some instances, an inferred value 510 can include captioning data; object detection data; knowledge graph data; or other inferred data associated with one or more frames 104, 106. For example, in some instances, an inferred value 510 can include entity detection data (e.g., natural language data, text data, numerical data, etc.) indicative of one or more entities depicted in one or more frames 104, 106. In some instances, entity detection data can include data identifying one or more detected entities (e.g., data describing, naming, or otherwise indicative of the entities); data indicative of a location of the entities (e.g., position relative to the frame 104, 106; relative to other entities; relative to one or more real-world locations such as cities, buildings, street addresses, etc.); data indicative of one or more relationships between the entities (e.g., spatial relationships, logical relationships, data relationships such as knowledge graph edges, etc.); data indicative of one or more attributes of the entities (e.g., color, size, shape, velocity, etc.); or other entity detection data. In some instances, knowledge graph data can include one or more tuplets indicative of one or more edges of a knowledge graph, such as triplets indicative of a first graph node, a second graph node, and an edge between the graph nodes. A knowledge graph can include, for example, a knowledge graph wherein each node is associated with one or more entities (e.g., entities depicted or not depicted in one or more frames 104, 106), and each edge represents a relationship between the one or more entities. In some instances, a knowledge graph can include one or more tuplets comprising identification data associated with one or more nodes (e.g., numerical node identifier, node name, etc.) and additional data indicative of one or more relationships between the nodes (e.g., numerical relationship type identifier, natural language relationship description, etc.). In some instances, an inferred value 510 can include or be associated with one or more machine-learned embeddings, such as a machine-learned embedding vector generated by a machine-learned model 108 based on a corresponding frame 104, 106 associated with the embedding.

In some instances, a post-query sampling request 512 can be, comprise, be comprised by, or otherwise share one or more properties with a sampling request 212 or timestamp request 312. For example, in some instances, a post-query sampling request 512 can have any property described herein with respect to a sampling request 212 or timestamp request 312, and vice versa. In some instances, a post-query sampling request 512 can include a sampling request 212 generated after a query 522 is received (e.g., from a user, by the machine-learned model 108, etc.), such as a sampling request 212 (e.g., timestamp request 312, etc.) based at least in part on the query 522. In some instances, a post-query sampling request 512 can be based in part on or not based on one or more stored values 526 retrieved based on the query 522. For example, in some instances, a machine-learned model 108 can receive a query 522; retrieve, based at least in part on the query, one or more stored values 526; and determine, based on one or more of the query 522 and stored values 526, whether one or more additional adaptively sampled frames 106 should be provided to generate a post-query sampling request 512. Responsive to the post-query sampling request 512, the machine-learned model 108 can receive one or more adaptively sampled frames 106, and can generate an inference output based on some or all of the query 522, the stored values 526, one or more frames 104, 106 provided to the machine-learned model 108 prior to the query 522, and the adaptively sampled frames 106 received based on the post-query sampling request 512. For example, in some instances, one or more frames 104, 106 that are provided to the machine-learned model 108 prior to the query 522 can be processed in a “prefill” step (e.g., encoding step, embedding step, etc.), and data generated during the prefill step (e.g., embedding data, etc.) can be retained (e.g., in a prefill data structure such as a key-value cache, etc.) after the query 522 is provided, and the data can be used to generate an inference output 110 responsive to the query (e.g., in addition to one or more additional inputs, such as stored values 526, adaptively sampled frames 106, query 522, etc.).

In some instances, one or more adaptively sampled frames 106 can also be provided to the machine-learned model 108 before the query 522 is received. For example, in some instances, a sampling framerate can vary according to one or more methods described above with respect to FIGS. 2-4 (e.g., based on a change rate determination 416, etc.). In some instances, a number of inferred values 510 generated by the machine-learned model 108 and stored in the inference storage structure 518 during a pre-query time period can be proportional to or otherwise correlated with a number of frames 104, 106 provided to the machine-learned model 108 during the pre-query time period. For example, in some instances, a machine-learned model 108 can generate an inferred value 510 for each frame 104, 106 provided to it, or an inferred value 510 for each j consecutive frames provided to it, wherein j can be an integer. Other implementations are possible.

An inference storage structure 518 can be or include one or more software, firmware, or hardware components for storing inferred values 510 (e.g., using one or more non-transitory computer-readable media). In some instances, an inference storage structure 518 can include one or more data structures for inferred values 510, such as one or more databases (e.g., relational database, NoSQL database, etc.), memory locations, or other data structures (e.g., any data structure described above with respect to a frame cache 314).

For example, in some instances, an inference storage structure 518 can include a data structure (e.g., database data structure, etc.) configured to provide efficient retrieval (e.g., O(1) or constant-time retrieval, O(log(stored value count)), etc.) of inferred values 510 based at least in part on a query 522, such as based on a comparison between a first machine-learned embedding (e.g., embedding vector, etc.) associated with the query 522 and a second machine-learned embedding associated with an inferred value 510. For example, an inference storage data structure 518 can in some instances include a vector database configured to efficiently retrieve adaptively sampled frames 106 based on vector embeddings associated with the inferred values 510. For example, in some instances, one or more (e.g., top k, where k is an integer, etc.) inferred values 510 can be retrieved based on a metric of similarity (e.g., distance metric such as cosine distance, Euclidean distance, etc.) between embeddings of the inferred values 510 and a corresponding embedding of the query 522. In some instances, an inference storage structure 518 can include one or more indexes to facilitate retrieval based on one or more indexed values, such as an index of machine-learned embeddings, an index of numerical identifiers, an index of timestamps, an index of one or more graph data structure components, or other index (e.g., keyword index, etc.). Other implementations are possible.

In some instances, an inference storage structure 518 can include or not include a data structure having a predetermined fixed size (e.g., limited-size memory structure stored in high-speed volatile memory of a computing system, etc.), and the inference storage structure 518 can be configured to remove or not remove one or more inferred values 510 from the inference storage structure 518 to fit within the predetermined fixed size (e.g., according to any method described above with respect to a frame cache 314, such as removing a percentage of inferred values having an age greater than a threshold, removing inferred values 510 that have not been retrieved often or are unlikely to be retrieved soon, etc.).

A query source 520 can include any source from which a query 522 can be received, such as a user; a computing device (e.g., smartphone, onboard computing device of a vehicle or robot, etc.); a communication device; or other query source.

A query 522 can generally include or otherwise represent various types of data. A query 522 can include one type or many different types of data. In some instances, a query 522 can include input context (e.g., question, instruction content, inference request, action request, etc.) received from a user. Example input types for a query 522 can include natural language such as voice or text natural language data; gesture data or other user input data; or another data type. In some instances, a query can include input context associated with past frames 104, 106 (e.g., frames 104, 106 stored in a frame cache 314 or already processed by a machine-learned model 108); input context associated with one or more future frames 104, 106 (e.g., frames that have not yet been obtained by the machine-learned model 108 or have not yet been obtained by the frame capture system 102, etc.); or both.

A retrieval 524 can include, for example, any action for retrieving a stored value 526 from an inference storage structure 518, or any signal to cause a stored value 526 to be retrieved from an inference storage structure 518. For example, in some instances, a retrieval 524 can include a retrieval query directed to a database associated with an inference storage structure 518, such as a vector embedding query directed to a vector database; a timestamp-based query or identifier-based query directed to a database (e.g., relational database, etc.); or other query. As another example, in some instances, a retrieval 524 can include a request (e.g., hypertext transfer protocol request, application programming interface request, etc.) sent to another device comprising an inference storage structure 518. Other retrievals 524 are possible.

A stored value 526 can include, for example, an inferred value 510 that has been stored in and retrieved from an inference storage structure 518. A stored value 526 can have any property described herein with respect to an inferred value 510, and vice versa.

FIG. 6 is a block diagram of an example system for adaptive input sampling in a client-server environment according to example implementations of some aspects of the present disclosure. One or more client devices 628 can each include a frame capture system 102 and one or more other components, such as a frame cache 314. One or more server devices 630 can each include one or more machine-learned models 108 and one or more other components, such as an inference storage structure 518. A client device 628 can transmit, over a communication channel, one or more baseline frames 104 to a server device 630. In some instances, the client device 628 can transmit, over a communication channel, one or more queries 522 (e.g., queries 522 received from a user of the client device 628) to the server device 630. Before or after the query 522, the server device 630 can transmit, over a communication channel (e.g., a network such as the internet), one or more pre-query sampling requests 612 or post-query sampling requests 512 to the client device. Responsive to receiving one or more sampling request(s) 512, 612, the server device 630 can transmit, over a communication channel, one or more adaptively sampled frames 106. Based at least in part on the adaptively sampled frames 106, the machine-learned model(s) 108 can generate one or more inference outputs 110. In some instances, the server device 630 can transmit, over a communication channel, the inference output(s) 110 to the client device 628, which can display the inference output(s) 110 to a user or perform another action based on the inference output(s) 110.

In some instances, a pre-query sampling request 612 can be, comprise, be comprised by, or otherwise share one or more properties with a sampling request 212 or timestamp request 312. For example, in some instances, a pre-query sampling request 612 can have any property described above with respect to a sampling request 212 or timestamp request 312, or vice versa. In some instances, a pre-query sampling request 612 can include a sampling request 212 that is provided to the client device 628 before any query 522 is received from the client device 628, or a sampling request 212 that is determined without regard to (e.g., not based on, etc.) any query 522. In some instances, a pre-query sampling request 612 can be determined based on a change rate determination 416 (e.g., as described above with respect to FIG. 4); based on one or more inferred values 510 (e.g., according to a change rate determination 416 based on the inferred values 510, etc.); based on one or more confidence values associated with one or more inferred values 510; or in another manner.

A client device 628 can be or include one or more software, firmware, or hardware components configured to obtain (e.g., generate, retrieve, receive, etc.) one or more baseline frames 104, adaptively sampled frames 106, or queries 522 and provide them to one or more server devices 630. In some instances, a client device 628 can be, comprise, be comprised by, or otherwise share one or more properties with a frame capture system 102. For example, in some instances, the client device 628 can have any property described herein with respect to a frame capture system 102, and vice versa. In some instances, the client device 628 can be, comprise, be comprised by, or share one or more properties with a computing device or system described below with respect to FIGS. 16-18 (e.g., computing device 50, third-party system 80, computing device 98, computing device 99, etc.).

In some instances, a client device 628 can include a client device in a client-server system, such as a mobile phone, smart glasses, augmented reality headset, wearable camera (e.g., helmet camera, chest-mounted clip-on camera, camera-equipped smart watch, etc.), laptop, desktop, or other client device. In some instances, a client device 628 can include a vehicle-mounted device (e.g., dashboard camera, onboard computing system, etc.) or vehicle component (e.g., lidar component, camera component, or other sensor component, etc.); a robot-mounted device or robot component (e.g., camera component, sensor component, imaging component, etc.); or the like. In some instances, a client device 628 can include one or more systems for providing stored video data (e.g., movies, YouTube videos, security camera footage, robot-mounted or vehicle-mounted video footage, etc.) or real-time video data (e.g., livestreamed video data from one or more internet-connected and camera-equipped client devices 628, etc.) to one or more server devices 630.

A server device 630 can be or include one or more software, firmware, or hardware components configured to generate one or more inference outputs 110 based on frames 104, 106 received from a client device 628. In some instances, the server device 630 can be, comprise, be comprised by, or share one or more properties with a computing device or system described below with respect to FIGS. 16-18 (e.g., server computing system 60, third-party system 80, computing device 98, computing device 99, etc.).

In some instances, a client-server system according to some aspects of the present disclosure can include one or more software, firmware, or hardware components configured to act as a live digital assistant, such as a machine-learned digital assistant configured to receive live video data (e.g., responsive to a user activating a live video assistant feature, etc.) and respond to one or more user queries (e.g., requests, questions, etc.) based on the video data. In some instances, the machine-learned digital assistant can be a “situated” agent that has access to one or more perceptual inputs (e.g., video inputs such as helmet camera or other wearable perceptual inputs, audio inputs, etc.) that at least partially correspond to a perceptual field of a user. For example, the video input can generally include at least a portion of the real world surrounding the user. In some instances, a client-server system can include a client device 628 configured to capture live video data, with the server side 630 comprising a machine-learned model 108 (e.g., machine-learned agent, etc.) configured to perform or select one or more actions associated with a live digital assistant (e.g., communication actions such as making a phone call over a telephone network or transmitting a text message or email over a communication channel; calendar actions such as scheduling an appointment or meeting or sending a calendar invite; navigation actions such as providing directions for traveling to a location associated with a query 522; web search action; online shopping action such as purchasing, ordering, or searching for goods or services based on a query 522; etc.). In some instances, a machine-learned model 108 can be configured to provide a signal (e.g., transmit a request over a communication network, etc.) to the client device 628 to cause the client device 628 or associated hardware (e.g., mobile phone, smart appliance, robot, vehicle, etc.) to perform an action (e.g., physical action such as heating, cooling, movement, manipulating a physical object, etc.; digital assistant action such as calendar action, communication action, etc.; or other action).

Although FIG. 6 depicts a server device 630 comprising a machine-learned model 108, a client device 628 can also include one or more machine-learned models 108 without deviating from the scope of the present disclosure. For example, in some instances, a client device 628 can include one or more lightweight first machine-learned models 108, and a server device 630 can include one or more second machine-learned models 108, wherein the first models can have a computational cost of inference (e.g., electricity cost, memory usage, processor usage) that is lower than a corresponding computational cost of inference of the second machine-learned models. For example, in some instances, a first machine-learned model on the client device 628 can have a reduced parameter count compared to a second machine-learned model on the server device 630; a reduced memory footprint compared to the second machine-learned model 108; a reduced precision (e.g., due to quantization of parameters, etc.) compared to the second machine-learned model 108; a reduced context window compared to the second machine-learned model 108; or may otherwise be associated with a reduced computational cost compared to a server-side machine-learned model 108. In some instances, a first machine-learned model 108 can include a reduced-memory-footprint device configured to fit in memory of a client device (e.g., edge device, etc.), such as a smartphone, augmented reality headset, wearable camera device, vehicle-mounted or robot-mounted device, or other client device. In some instances, a first machine-learned model 108 on the client device 628 can perform various functions, such as generating preliminary inference outputs 110; generating inference outputs 110 responsive to queries 522 comprising or based on data that is not provided to the server device 630 (e.g., for data privacy reasons, etc.); generating intermediate inferred values 510; generating sampling requests 212 or data to be used in a sampling rate determination (e.g., as described above with respect to FIGS. 2-4); or other functions.

In some instances, the client device 628 can transmit one or more baseline frames 104 to the server device 630 over a communication channel; generate (e.g., according to methods described above with respect to FIGS. 2-4, etc.) or obtain (e.g., receive from a server device 630, etc.) one or more sampling requests 212 indicating whether one or more adaptively sampled frames 106 should be transmitted to the server device 630 over the communication channel; and transmit, responsive to data indicating that the adaptively sampled frames 106 should be transmitted, the adaptively sampled frames 106 over the communication channel. In this manner, for instance, a volume of communication between the client device 628 and server device 630 can be advantageously reduced compared to some alternative implementations.

FIG. 7 is a block diagram of an example system for training a machine-learned model for adaptive input sampling according to example implementations of some aspects of the present disclosure. A training system 732 can obtain a training dataset 734 comprising a plurality of training examples. Each training example can include, for example, one or more input-output pairs comprising one or more training inputs 736 and one or more ground-truth outputs associated with the training input(s) 736. For each of a plurality of training iterations, the training system 732 can provide, to one or more machine-learned models 108, one or more training inputs 736. The machine-learned model(s) 108 can generate, based at least in part on the training input(s) 736, one or more training outputs 712. The training system 732 can evaluate the one or more training outputs 712 based on an objective function. The training system 732 can provide, based on an evaluation of the training outputs 712, one or more model updates 738 to the machine-learned model 108.

In some instances, a training output 712 can be, comprise, be comprised by, or otherwise share one or more properties with a sampling request 212. In some instances, a training output 712 can be, comprise, be comprised by, or otherwise share one or more properties with an inference output 110. For example, in some instances, a training output 712 can have any property described herein with respect to a sampling request 212 or inference output 110, and vice versa.

A training system 732 can be or include one or more software, firmware, or hardware components configured to provide model updates 738 to a machine-learned model 108 based on training outputs 712 generated by the machine-learned model 108. In some instances, the training system 732 can be, comprise, be comprised by, or share one or more properties with a computing device or system described below with respect to FIGS. 16-18 (e.g., computing device 50, third-party system 80, computing device 98, computing device 99, etc.).

A training dataset 734 can include, for example, a plurality of training examples, wherein each training example can include one or more training inputs 736, one or more corresponding outputs (e.g., ground truth outputs, etc.) associated with the training inputs 736, or other data. A training example can generally include or otherwise represent various types of data. A training example can include one type or many different types of data. Example datatypes can include, for example, natural language data (e.g., text data, etc.); frame 104, 106 data; query 522 data; or other data types described above with respect to FIGS. 1-6. Similarly, a training input 736 can include or otherwise represent various types of data, and can include one type or many different types of data (e.g., natural language data, frame 104, 106 data, query 522 data, etc.).

In some instances, a training example of a training dataset can include one or more of input context data, ground-truth inference outputs 110, ground-truth sampling request 212 data, or other information. In some instances, input context data can include one or more of: baseline frame(s) 104 to be provided as a first training input 736; queries 522 to be provided as a second training input 736; adaptively sampled frames 106 to be optionally provided as a third training input 736 responsive to a training output 712 comprising a sampling request 212 (e.g., as part of a reinforcement learning process, etc.); or other input context. Ground-truth sampling request 212 data can include, for example, data (e.g., timestamp request 312 data, etc.) indicative of a time range associated with frames 104, 106 for responding to a query 522; data indicative of one or more sampling framerates (e.g., minimum necessary framerate for answering a query, ground truth or preferred framerate for a particular video segment, etc.), such as a ground truth sampling request 212 indicative of a ground truth framerate that should be requested responsive to a training input 736; data indicative of one or more sampling resolutions (e.g., minimum necessary resolution for answering a query, ground truth or preferred resolution for a particular video segment, etc.); or other data indicating whether one or more adaptively sampled frames 106 should be sampled.

In some instances, some or all of a training dataset 734 can be generated using human annotation, or some or all of the training dataset 734 can be automatically generated without human intervention. For example, in some instances, one or more humans (e.g., users, annotators, etc.) can generate one or more training input 736 components (e.g., queries 522, etc.); one or more ground truth outputs (e.g., ground truth sampling requests 212, ground truth inference outputs 110, etc.); one or more reward signals (e.g., numerical rating indicative of the quality of a training output 712 displayed to the human, etc.); or other annotation data. For example, in some instances, one or more humans can be provided with video data (e.g., movie data, etc.), and the humans can generate one or more queries 522; ground truth responses to the queries 522; timestamp annotations indicating which frames 104, 106 include or are associated with necessary, sufficient, or relevant data (e.g., image data, audio data, etc.) for responding to the query 522; or other annotations (e.g., resolution annotations indicating which resolutions are sufficient for answering the query, frame cropping data indicating a portion of a frame 104, 106 comprising necessary, sufficient, or relevant data for responding to the query 522, etc.).

In some instances, all or part of a training dataset 734 can be generated by one or more computing devices (e.g., without human intervention). For example, in some instances, a computing device can obtain (e.g., generate, receive, retrieve, be provided with, etc.) data (e.g., ground-truth data, machine-learned inferred data, etc.) associated with one or more frames 104, 106 and can generate training examples based on the data. For example, in some instances, data associated with the frames 104, 106 can include data describing content (e.g., humans, animals, objects, events, etc.) depicted in a corresponding frame 104, 106. Based on such data, a computing system (e.g., using a machine-learned model 108 such as a language model) can generate one or more queries 522 that are expected to be answerable using the corresponding frame 104, 106. In some instances, a computing system can confirm that a query 522 is answerable using the corresponding frame 104, 106 by providing the frame 104, 106 to a machine-learned model 108 and comparing an output of the machine-learned model 108 to an expected output. In some instances, a ground-truth timestamp request 312 can be determined based on a timestamp of the corresponding frame 104, 106, and a training example comprising the query 522 and the ground-truth timestamp request 312 can be added to the training dataset 734.

In some instances, one or more ground-truth sampling requests 212 can be generated by performing a plurality of inference actions using a machine-learned model 108, and determining a ground-truth sampling request 212 based on a result of the plurality of inferences. For example, in some instances, a computing system can obtain an input-output pair comprising a query 522 and a ground-truth output associated with the query 522. The computing system can provide a small number of baseline frames 104 (e.g., low-resolution baseline frames 104, etc.) to a machine-learned model 108, and the machine-learned model 108 can generate an inference output 110 based on the baseline frames 104. Based on a comparison between the inference output 110 and the ground-truth output, the computing system can determine whether the baseline frames 104 were sufficient for the machine-learned model 108 to generate the ground-truth output. The process can be repeated at one or more higher frame counts (e.g., by providing adaptively sampled frames 106 to the machine-learned model 108, etc.), one or more higher resolutions, or both. The process can be repeated, for example, until the machine-learned model 108 generates the ground-truth output, or until a fixed maximum number of attempts are performed. Based on the inference results, one or more ground-truth sampling requests 212 can be generated, and a training example comprising a corresponding training input 736-sampling request 212 pair can be added to the training dataset 734. For example, a ground-truth sampling request 212 or ground-truth plurality of sampling requests 212 can include sampling requests 212 sufficient to provide the machine-learned model 108 with the minimum sampling framerate and resolution at which the ground-truth output was generated. In some instances, a training example for which a ground-truth output was not generated can be paired with a no-operation sampling request 212; paired with a maximum-framerate or maximum-resolution sampling request 212; paired with a minimum-framerate or minimum-resolution sampling request 212; omitted from a training dataset 734; or processed in another way.

As another example, in some instances, a training dataset 734 can include one or more training examples comprising a training input 736 comprising query 522 data, and a corresponding training output 712 comprising a ground-truth inference output 110. In some instances, one or more machine-learned models 108 can be trained on such training examples according to a reinforcement learning process. For example, the machine-learned model(s) can generate one or more sampling requests 212; receive one or more adaptively sampled frames 106 based on the sampling requests 212; generate one or more inference outputs 110 (e.g., based on the query 522, adaptively sampled frames 106, baseline frames 104, or other data). A training system 732 can determine a reward signal (e.g., by evaluating an objective function) indicative of a quality of the inference outputs 110, and the model updates 738 can be determined based at least in part on the reward signal. For example, the reward signal can be used to update one or more parameters (e.g., weights) used to generate the sampling requests 212 (e.g., according to a backpropagation process associated with a reinforcement learning method, backpropagation process associated with the sampling request 212 generation, etc.). An example reward signal can include, for example, an objective function comprising one or more reward values to reward an inference output 110 that matches a ground truth output, and one or more penalty values (e.g., loss values, cost values, etc.) based on one or more of: a number of adaptively sampled frames 106 sampled, a resolution of adaptively sampled frames 106 used to generate the inference output 110, a cost (e.g., computation cost, financial cost, electricity cost, etc.) of sampling the adaptively sampled frames 106, or other relevant value.

In some instances, a training dataset 734 can include data configured to train a machine-learned model 108 to generate timestamp requests 312 to request specific adaptively sampled frames 106 (e.g., post-query sampling requests 512 responsive to a query 522 regarding an event that has already occurred, etc.); pre-query sampling requests 612 configured to request changes to a sampling framerate or sampling resolution in the absence of a query 522; or other sampling requests 212. For example, in some instances, training examples configured to train a machine-learned model 108 to generate pre-query sampling requests 612 can include training inputs 736 comprising frame 104, 106 data (e.g., baseline frame 104 data, etc.) and one or more ground truth sampling requests 212 or other output data associated with the training inputs 736. In some instances, such training examples can be generated based in part on queries 522, which can be omitted from the training inputs 736. For example, in some instances, a computing system (or human annotator, etc.) can obtain data comprising video data (e.g., movie, streaming video data, etc.) and a plurality of queries 522 associated with the video data (e.g., queries 522 received from users during viewing of a movie, etc.); determine a framerate, resolution, one or more frame identifiers, or other data indicative of frames 104, 106 that may be necessary, sufficient, or relevant for responding to the query 522; and determine, based on the data indicative of the frames 104, 106, one or more pre-query sampling requests 612 to include in a training example. Pre-query sampling requests 612 to include in a training example can include, for example, pre-query sampling requests 612 that would have caused a machine-learned model 108 to receive (e.g., before a query 522 is received, etc.) enough frames 104, 106 to accurately respond to a query 522. In some instances, pre-query sampling requests 612 to include in a training example can include pre-query sampling requests 612 that would have provided other benefits, such as a pre-query sampling request 612 to reduce a sampling framerate or sampling resolution during a video segment for which few queries 522 were received during collection of the training data, or for which queries 522 can be answered based on fewer or lower-resolution frames 104, 106.

In some instances, a training dataset 734 can include training data configured to train a machine-learned model 108 to generate various kinds of post-query sampling requests 512. For example, in some instances, a machine-learned model 108 can be trained to generate post-query sampling requests 512 for a query 522 about a future event, such as a query 522 associated with frames 104, 106 that have not yet been captured. For example, a machine-learned model 108 can be trained to receive a query 522; anticipate, based in part on the query 522 and based in part on one or more baseline frames 104, when frames 104, 106 relevant to the query 522 are likely to appear; and adjust (e.g., increase, etc.) a sampling framerate or sampling resolution before the frames 104, 106 relevant to the query 522 are captured by the frame capture device 102. For example, in some instances, a training example for training a machine-learned model 108 to anticipate relevant upcoming frames 104, 106 can include training inputs 736 comprising a query 522 and a plurality of frames 104, 106; outputs comprising ground truth post-query sampling request 512 data; or other data. The ground truth post-query sampling request 512 data can include, for example, one or more post-query sampling requests 512 configured to cause the machine-learned model 108 to receive frames 104, 106 that are sufficient, necessary, or otherwise relevant to respond to the query 522. In some instances, a ground truth sampling request 212 can include a sampling request 212 to decrease a sampling framerate or sampling resolution, such as a post-query sampling request 512 to decrease a sampling framerate or sampling resolution after sufficient frames 104, 106 to answer the query 522 have been received, or after an inference output 110 responsive to the query 522 is generated.

Model updates 738 can include parameter update data (e.g., numerical parameter update values, etc.) for updating one or more parameters (e.g., weights, etc.) of the machine-learned model 108. In some instances, a machine-learned model 108 can include one or more pretrained layers (e.g., embedding layers, etc.) and one or more additional layers (e.g., adapter layers, output layers, etc.). In some instances, a model update 738 can include data for updating one or more parameters of the additional layers (e.g., with or without updating the pretrained layers, etc.). In some instances, a numerical value for updating a parameter can include an adjustment value to be added to or subtracted from the corresponding parameters. Other values are possible (e.g., adjustment value to multiply or divide a parameter by, replacement parameter value to replace a prior parameter, etc.). In some instances, a data structure for storing or transmitting model updates 738 can include one or more tensors (e.g., matrices, vectors, etc.).

In some instances, determining a model update 738 can include evaluating an objective function. In some instances, an objective function can include a reward function or loss function, such as a reward or loss function comparing a training output 712 to a corresponding ground truth output. A ground truth output can include, for example, a ground truth sampling request 212 or ground truth inference output 110 (e.g., associated with query 522 data of a training input 736, etc.), such as a ground truth sampling request 212 provided by a human annotator or generated according to a synthetic data creation process.

In some instances, determining a model update 738 can include backpropagation. For example, in some instances, a training system 732 can evaluate a loss function based on a training output 712 and one or more ground truth outputs, and can generate a loss value associated with the training output 712. In some instances, the training system 732 can determine one or more gradients of the loss function and can determine one or more model updates 738 based on the gradient(s). In some instances, a model update 738 can be scaled according to a learning rate parameter (e.g., by multiplying a gradient value by the learning rate parameter, etc.) or other scaling value (e.g., clipping value, normalization value, Adam optimization parameter, etc.).

In some instances, the training process described herein can be adapted to one or more machine-learned models 108 for generating video data. For example, in some instances, an autoregressive video generation model can be configured to generate video frames at variable resolution or variable framerate, and the autoregressive video generation model or a separate framerate determination model can adaptively select a framerate or resolution at which the video generation model autoregressively generates video frames. In some instances, an adaptive framerate determination model for machine-learned generation of frames 104, 106 can be trained in any manner described herein, using a training dataset 734 that is the same as or different from a training dataset 734 for processing input frames 104, 106. For example, in some instances, ground truth sampling requests 212 for video generation can include ground truth sampling requests 212 determined in a manner described above, or ground truth sampling requests 212 determined based on output quality data associated with one or more video generation outputs, such as data indicative of a minimum framerate for smoothly depicting motion (e.g., keeping a metric of motion blur below a threshold, etc.) between frames, which may vary depending according to an amount of motion in the frame (e.g., according to a change rate determination 416 metric, etc.); data indicative of a preferred resolution based on the framerate, an amount of motion, a number of objects depicted in the frame, or other variables; or other method for determining ground truth sampling requests 212 for video generation. In some instances, one or more components (e.g., machine-learned models 108, computing systems, etc.) for adaptive-framerate or adaptive-resolution frame 104, 106 generation can have any property described herein with respect to components adaptive-framerate or adaptive-resolution frame 104, 106 processing or analysis, and can be trained or used in any manner described herein with respect to a corresponding frame 104, 106 processing component.

### Example Methods

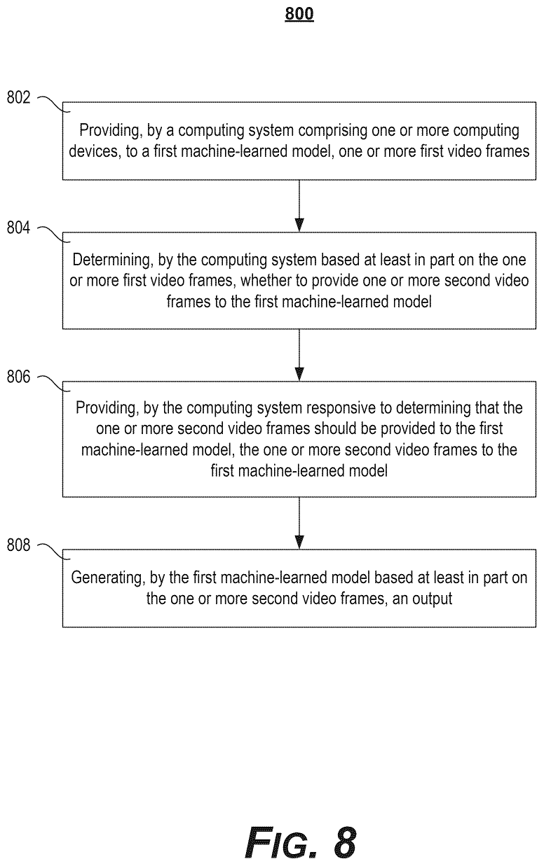

FIG. 8 is a flow chart diagram of an example method for adaptive frame sampling according to example implementations of some aspects of the present disclosure. Although FIG. 8 depicts steps performed in a particular order for purposes of illustration and discussion, the methods of the present disclosure are not limited to the particularly illustrated order or arrangement. The various steps of example method 800 can be omitted, rearranged, combined, and/or adapted in various ways without deviating from the scope of the present disclosure.

At 802, example method 800 can include providing, by a computing system comprising one or more computing devices, to a first machine-learned model (e.g., machine-learned model 108, etc.), one or more first video frames (e.g., baseline frames 104, etc.). In some instances, example method 800 at 802 can include using one or more systems or performing one or more activities described with respect to FIGS. 1-6.

At 804, example method 800 can include determining, by the computing system based at least in part on the one or more first video frames (e.g., based on a sampling request 212, based on a change rate determination 416, etc.), whether to provide one or more second video frames (e.g., adaptively sampled frames 106, etc.) to the first machine-learned model. In some instances, example method 800 at 804 can include using one or more systems or performing one or more activities described with respect to FIGS. 1-6.

At 806, example method 800 can include providing, by the computing system responsive to determining that the one or more second video frames should be provided to the first machine-learned model, the one or more second video frames to the first machine-learned model. In some instances, example method 800 at 806 can include using one or more systems or performing one or more activities described with respect to FIGS. 1-6.

At 808, example method 800 can include generating, by the first machine-learned model based at least in part on the one or more second video frames, an output (e.g., inference output 110, inferred value 510, etc., etc.). In some instances, example method 800 at 808 can include using one or more systems or performing one or more activities described with respect to FIGS. 1-6.

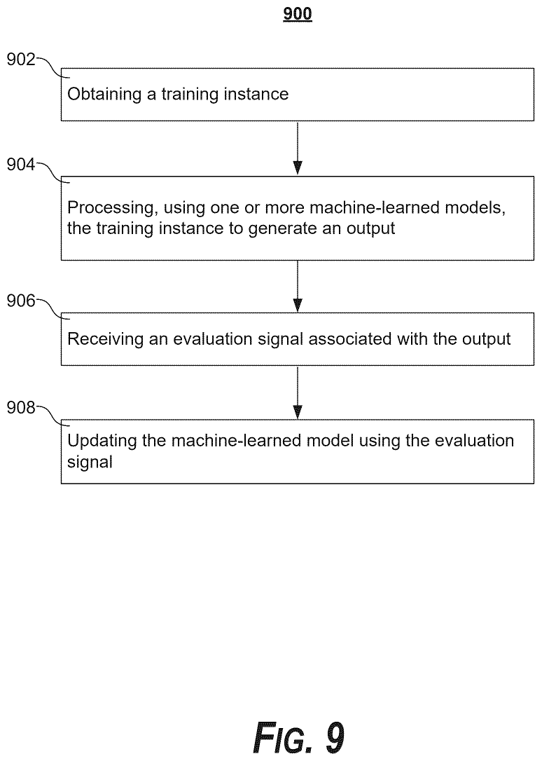

FIG. 9 depicts a flowchart of a method 900 for training one or more machine-learned models according to aspects of the present disclosure. For instance, an example machine-learned model can include a machine-learned model 108.

One or more portion(s) of example method 900 can be implemented by a computing system that includes one or more computing devices such as, for example, computing systems described with reference to the other figures. Each respective portion of example method 900 can be performed by any (or any combination) of one or more computing devices. Moreover, one or more portion(s) of example method 900 can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of example method 900 can be performed additionally, or alternatively, by other systems.

At 902, example method 900 can include obtaining a training instance. A set of training data can include a plurality of training instances divided between multiple datasets (e.g., a training dataset, a validation dataset, or testing dataset). A training instance can be labeled or unlabeled. Although referred to in example method 900 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 904, example method 900 can include processing, using one or more machine-learned models, the training instance to generate an output. The output can be directly obtained from the one or more machine-learned models or can be a downstream result of a chain of processing operations that includes an output of the one or more machine-learned models.

At 906, example method 900 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 908, example method 900 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 900 can include implementing a number of generalization techniques (e.g., weight decays, dropouts, etc.) to improve the generalization capability of the models being trained.

In some implementations, example method 900 can be implemented for training a machine-learned model from an initialized state to a fully trained state (e.g., when the model exhibits a desired performance profile, such as based on accuracy, precision, recall, etc.).

In some implementations, example method 900 can be implemented for particular stages of a training procedure. For instance, in some implementations, example method 900 can be implemented for pre-training a machine-learned model. Pre-training can include, for instance, large-scale training over potentially noisy data to achieve a broad base of performance levels across a variety of tasks/data types. In some implementations, example method 900 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

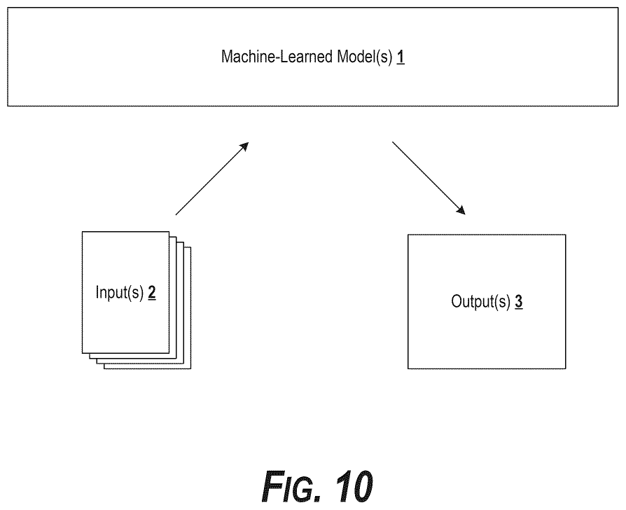

FIG. 10 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), chemical or biochemical data, image data, audio data, audiovisual data, haptic data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and astronomical data, sensor data and chemical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

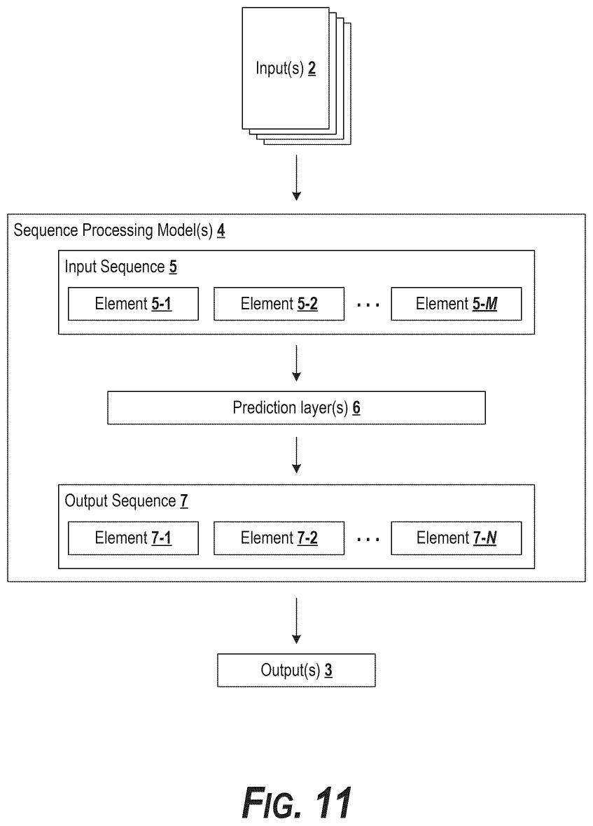

FIG. 11 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 11 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

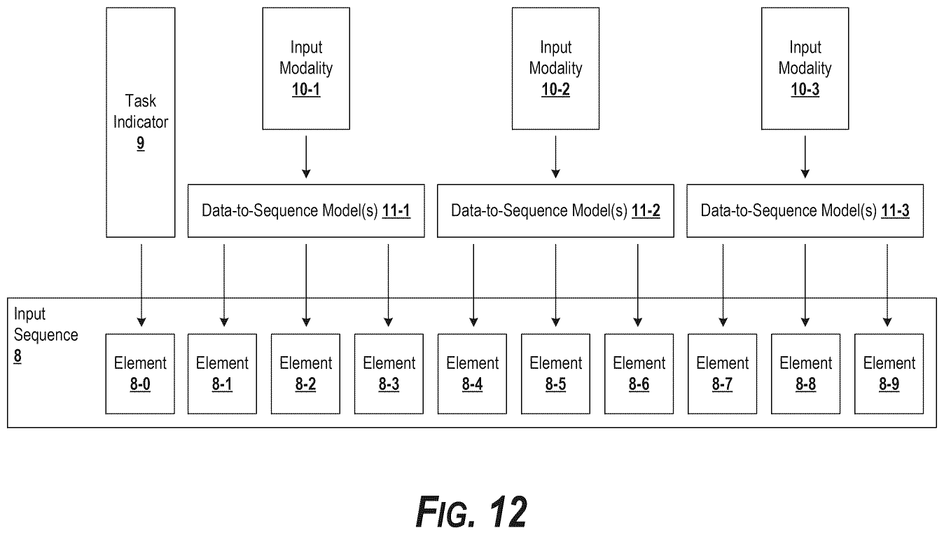

FIG. 12 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

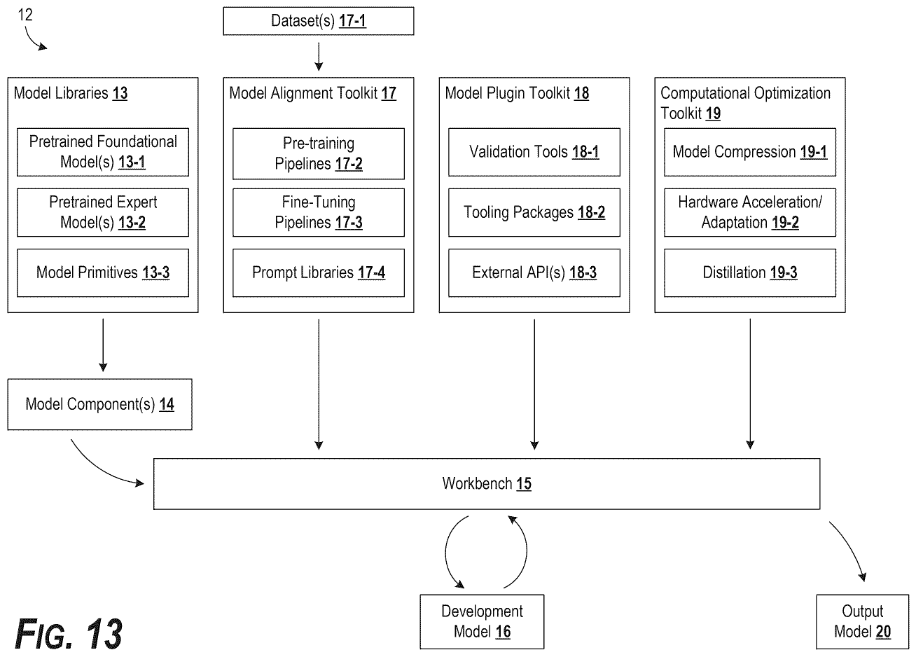

FIG. 13 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 900 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

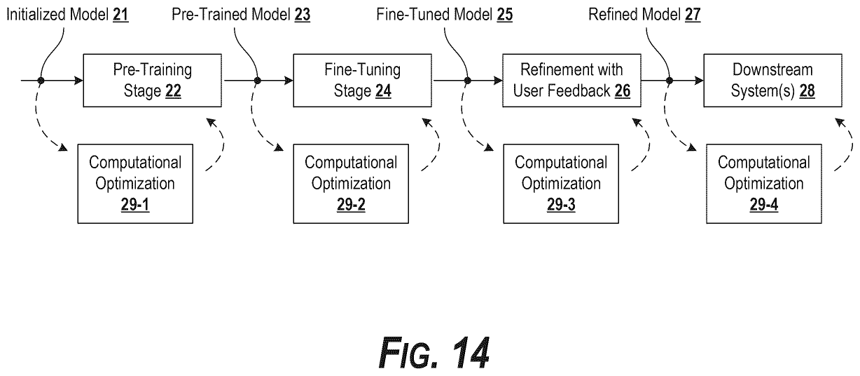

FIG. 14 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

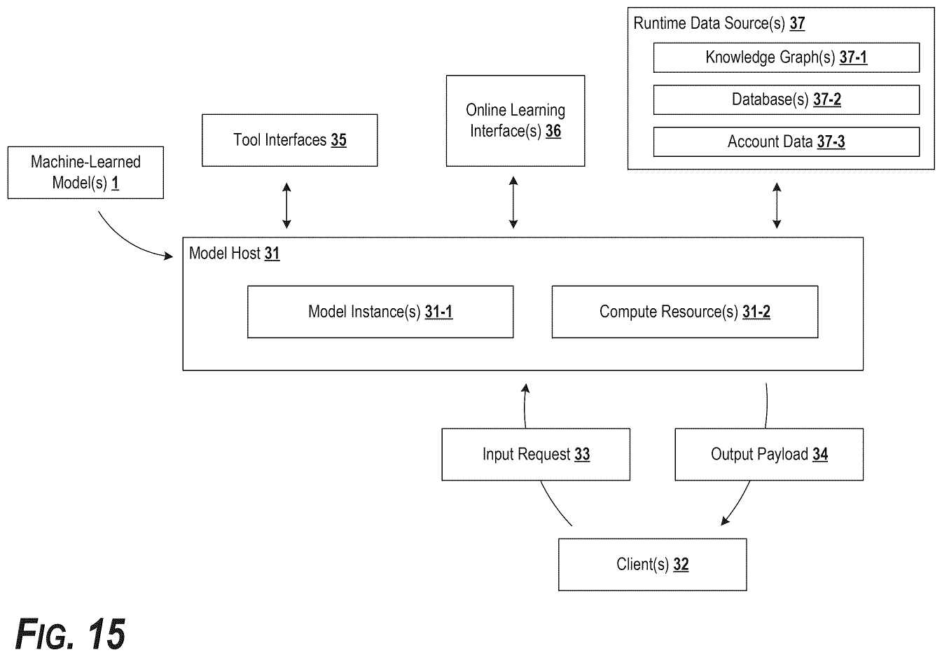

FIG. 15 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 16 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 16 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 16 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

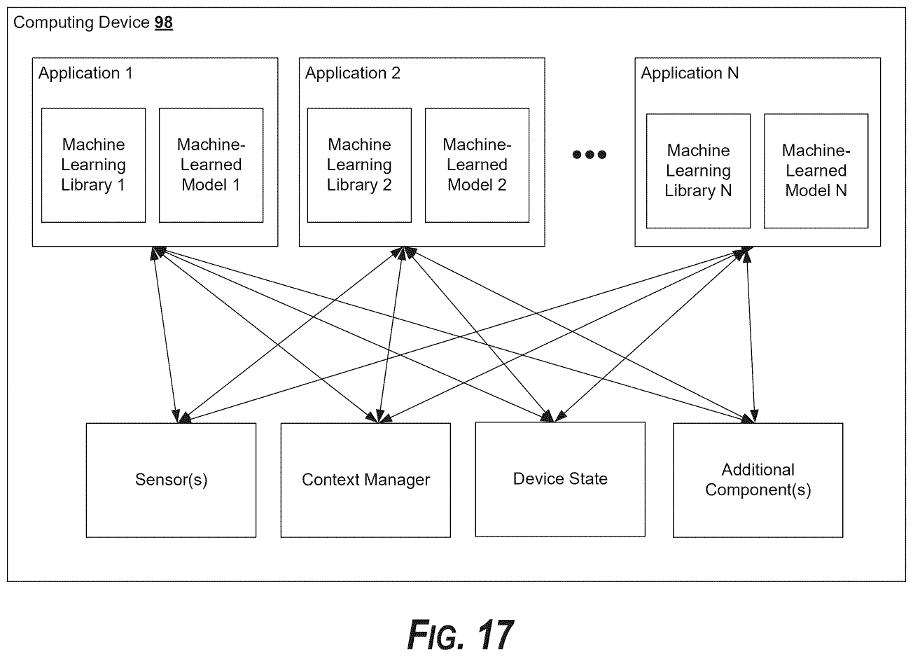

FIG. 17 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 17, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

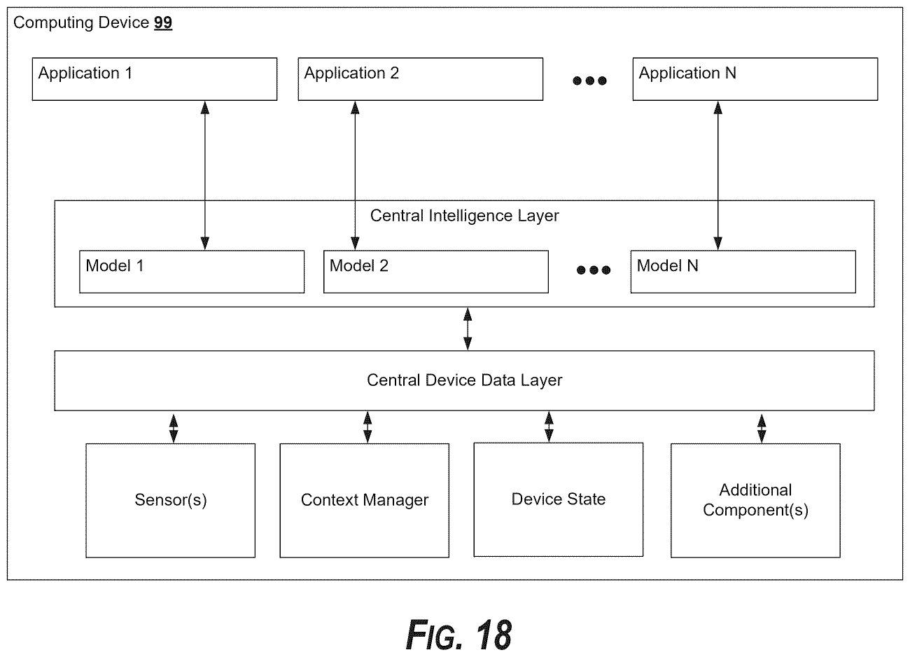

FIG. 18 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 18, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 18, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method, comprising:
providing, by a computing system comprising one or more computing devices, to a first machine-learned model, one or more first video frames;
determining, by the computing system based at least in part on the one or more first video frames, whether to provide one or more second video frames to the first machine-learned model;
providing, by the computing system responsive to determining that the one or more second video frames should be provided to the first machine-learned model, the one or more second video frames to the first machine-learned model; and
generating, by the first machine-learned model based at least in part on the one or more second video frames, an output.

2. The method of claim 1, wherein the one or more second video frames are stored in a video cache, and further comprising:
retrieving, by the computing system responsive to determining that the one or more second video frames should be provided to the first machine-learned model, the one or more second video frames from the video cache.

3. The method of claim 1, wherein determining whether the one or more second video frames should be provided to the first machine-learned model comprises determining whether to increase a sampling rate at which a video stream comprising a plurality of video frames is provided to the first machine-learned model, and wherein providing the one or more second video frames to the first machine-learned model comprises increasing the sampling rate.

4. The method of claim 3, wherein determining whether to increase the sampling rate comprises determining based at least in part on a metric of difference between at least one earlier frame of the one or more first video frames and at least one later frame of the one or more first video frames.

5. The method of claim 3, wherein determining whether to increase the sampling rate comprises determining based at least in part on a metric indicative of an amount of motion associated with the one or more first video frames.

6. The method of claim 3, further comprising:
determining, by the computing system based at least in part on the one or more second video frames, that the sampling rate should be decreased; and
decreasing, by the computing system responsive to determining that the sampling rate should be decreased, the sampling rate.

7. The method of claim 1, wherein determining whether to provide the one or more second video frames to the first machine-learned model comprises:
providing, by the computing system to the first machine-learned model or a second machine-learned model, a first input context comprising the one or more first video frames; and
receiving, by the computing system from the first machine-learned model or the second machine-learned model, data indicating whether the one or more second video frames should be provided to the first machine-learned model.

8. The method of claim 7, wherein the data indicating whether the one or more second video frames should be provided to the first machine-learned model comprises one or more of:
frame identification data identifying the one or more second video frames;
confidence data indicative of a confidence of the first machine-learned model in relation to one or more queries;
one or more output tokens indicative of a request to increase a sampling rate; and
one or more output tokens indicative of a request to increase a frame resolution.

9. The method of claim 7, wherein the first input context further comprises one or more of:
instruction content comprising an instruction to determine whether the one or more second video frames should be provided to the first machine-learned model; and
chain-of-thought content comprising one or more example input-output pairs comprising one or more example outputs indicative of a determination that additional video frame input should be obtained.

10. The method of claim 7, wherein the first machine-learned model comprises a model that was trained by:
obtaining a training dataset comprising a plurality of training examples, wherein each training example of the plurality of training examples comprises a training input comprising one or more input video frames and one or more training outputs, the training outputs comprising data indicating whether additional video frame input should be obtained; and
for each of a plurality of training iterations:
providing, to the first machine-learned model, a respective training input of a respective training example of the plurality of training examples;
generating, by the first machine-learned model, an inference output based on the respective training input;
evaluating, based on a comparison between the inference output and a respective training output of the respective training example, an objective function; and
updating, based at least in part on the objective function, the first machine-learned model.

11. The method of claim 1, further comprising:
receiving, by the computing system from the first machine-learned model, one or more first inference outputs; and
storing, by the computing system in an inference storage data structure, the one or more first inference outputs.

12. The method of claim 11, wherein determining whether to provide the one or more second video frames to the first machine-learned model comprises:
retrieving, by the computing system from the inference storage data structure, at least one first inference output of the one or more first inference outputs;
providing, by the computing system to the first machine-learned model or a second machine-learned model, the at least one first inference output; and
receiving, by the computing system from the first machine-learned model or the second machine-learned model based on the at least one first inference output, data indicating whether the one or more second video frames should be provided to the first machine-learned model.

13. The method of claim 11, wherein the one or more first inference outputs comprise data indicative of one or more identified positions of one or more objects depicted in the one or more first video frames.

14. The method of claim 11, wherein the first machine-learned model comprises a multimodal model configured to process text and image data, and wherein the one or more first inference outputs comprise one or more image captions generated by the first machine-learned model based on the one or more first video frames.

15. The method of claim 1, wherein the one or more first video frames are provided to the first machine-learned model at a first resolution, and further comprising:
determining, by the computing system based at least in part on the one or more first video frames, whether to provide the one or more second video frames to the first machine-learned model at a second resolution that is higher than the first resolution;
wherein the one or more second video frames are provided at the second resolution responsive to determining that the one or more second video frames should be provided at the second resolution.

16. The method of claim 1, wherein the computing system comprises one or more server devices, and further comprising:
sending, by the one or more server devices to a client device, a request for the one or more second video frames; and
receiving, by the one or more server devices from the client device, the one or more second video frames.

17. The method of claim 1, further comprising:
receiving, by the computing system, a query; and
providing, by the computing system, the query to the first machine-learned model;
wherein the output is generated based at least in part on the query.

18. The method of claim 1, wherein the one or more first video frames are sampled in real time from streamed video data according to a first sampling rate, and wherein the one or more first video frames are provided to the first machine-learned model at a rate that is between 0.8 and 1.2 times the first sampling rate.

19. A computing system comprising one or more processors and one or more non-transitory computer-readable media storing instructions that are executable by one or more processors to cause the computing system to perform operations, the operations comprising:
providing, to a first machine-learned model, one or more first portions of first time series data;
determining, based at least in part on the one or more first portions, whether to provide one or more second portions of the first time series data to the first machine-learned model;
providing, responsive to determining that the one or more second portions should be provided to the first machine-learned model, the one or more second portions to the first machine-learned model; and
generating, by the first machine-learned model based at least in part on the one or more second portions, an output.

20. The method of claim 19, wherein the first time series data comprises audio time series data.

21. The computing system of claim 19, wherein the first time series data comprises sensor data comprising one or more of:
biological data;
environmental data;
industrial data; and
data indicative of a motion, position, or orientation of the computing system or a user of the computing system.

22. One or more non-transitory computer-readable media storing instructions that are executable by one or more processors to cause a computing system to perform operations, the operations comprising:
determining, based at least in part on one or more first video frames, whether to provide one or more second video frames to a first machine-learned model;
providing, responsive to determining that the one or more second video frames should be provided to the first machine-learned model, the one or more second video frames to the first machine-learned model; and
generating, by the first machine-learned model based at least in part on the one or more second video frames, an output.
